(19) United States
(12) Patent Application Publication
(10) Pub. No.: US 2008/0086894 A1
(43) Pub. Date: Apr. 17, 2008

(54) FOLDING UTILITY KNIFE

(75) Inventor: Scott L. Sullivan, San Francisco, CA (US)

Correspondence Address: DARBY & DARBY P.C., P.O. BOX 770, Church Street Station, New York, NY, 10008-0770, US

(73) Assignee: Great American Tool Co.

(21) Appl. No.: 11/874,071

(22) Filed: Oct. 17, 2007

Related U.S. Application Data
(60) Provisional application No. 60/829,858, filed on Oct. 17, 2006.
(60) Provisional application No. 60/956,307, filed on Aug. 16, 2007.

(51) Int. Cl. B26B 21/40

(52) U.S. Cl. 30/155

(57) ABSTRACT

A folding utility knife for holding a razor blade. The knife includes a handle and two independently pivotal planar blade-holding jaws that are, in turn, pivotally attached to the handle. The jaws define an interposed blade-receiving space that is sized and shaped to receive and hold a blade, when the jaws are in a closed position, and release the blade, when the jaws are in an open position. A locking clip is slidable along one of the jaws between a locked and unlocked position. The locking clip can be slid into the locked position when the two jaws are located in the closed position so that the jaws remain closed. When the clip is slid to the unlocked position, the jaws are permitted to pivot to the open position, so that the blade can be removed or inserted. Another embodiment provides a ratchet lock mechanism in place of the slider locking clip.

### CROSS-REFERENCE TO RELATED APPLICATIONS

The present application claims the benefit of U.S. patent application Ser. No. 60/829,858, filed Oct. 17, 2006 and U.S. patent application Ser. No. 60/956,307, filed Aug. 16, 2007, each of which is hereby expressly incorporated by reference in its entirety.

### TECHNICAL FIELD

The present invention generally relates to folding knives, and more particularly, to such knives that are designed to hold a utility-type razor blade. Many of the improvements of this invention can be applied to folding knives that utilize non-removable blades as well.

### BACKGROUND

There are several folding knives on the market today that are designed to hold a utility-type razor blade (in place of a non-removable knife blade). The razor blade of these prior art knives is removable and generally speaking, is relatively easy to replace with a new sharp blade. These knives are foldable and thereby provide the convenience of a compact box-cutting tool that can be easily stowed and carried.

One problem with these knives is that too many parts are used, which increases their cost and assembly time, as well as their susceptibility to damage during use.

Another problem with many of these knives is that a tool is required to remove the razor blade. In some cases, a lever action is used to release a blade, but often the user's fingers are forced to interact dangerously close to the sharp blade during the removal and installation process.

A first object of the present invention is to overcome the deficiencies of the prior art.

A second object is to provide a simple folding knife that uses few parts and is very easy to assemble.

A third object of the invention is to provide a folding knife that includes components that allow the razor blade to be easily replaced, yet holds an inserted blade safely and firmly.

Other and further objects of the invention will be obvious upon an understanding of the illustrative embodiment about to described, or will be indicated in the appended claims and various advantages not referred to herein will occur to one skilled in the art upon employment of the invention in practice.

### SUMMARY

A folding utility knife for holding a razor blade includes a handle and two independently pivotal planar blade-holding jaws that are, in turn, pivotally attached to the handle. The jaws define an interposed blade-receiving space that is sized and shaped to receive and hold a blade, when the jaws are in a closed position, and release the blade, when the jaws are in an open position. A locking clip is slidable along one of the jaws between a locked and unlocked position. The locking clip can be slid into the locked position when the two jaws are located in the closed position so that the jaws remain closed. When the clip is slid to the unlocked position, the jaws are permitted to pivot to the open position, so that the blade can be removed or inserted.

According to another embodiment of the invention, in place of the sliding locking clip a locking ratchet is used to lock the cover jaw to the main jaw in the closed position. Here, a spring-biased curved ratchet arm with engagement teeth is integrally formed to the cover jaw and a mating ratchet arm with engagement teeth is integrally formed to the main jaw. In use, as the user closes the cover jaw with respect to the main jaw, the teeth of both ratchet arms move into mechanical engagement and hold the cover jaw closed about an interposed blade. To release the blade, the user merely pulls curved ratchet arm of cover jaw against its spring-bias and simultaneously angularly displace cover jaw with respect to main jaw to provide access to the blade held therebetween.

Another feature of the invention includes a logo window located on the handle of the knife which is positioned to align with a logo printed on the pivotal blade holding jaws (or knife blade) so that when the blade holder is stowed within the knife handle, the logo may be viewed through the logo window.

### BRIEF DESCRIPTION OF THE DRAWING FIGURES

A preferred embodiment of the invention has been chosen for purposes of illustration and description and is shown in the accompanying drawings forming a part of the specification, wherein:

FIG. 1 is a perspective assembly view of a folding utility knife, according to the present invention, showing three main sections of the knife; a blade holder, a liner/clip and a handle section;

FIG. 2 is a perspective view of the handle section of the knife of FIG. 1, according to the present invention;

FIG. 3 is an exploded perspective view of the handle section of the knife of FIG. 2, showing side and top panels, according to the invention;

FIG. 4 is a perspective view of the liner/clip section of the knife of FIG. 1, showing a body, an engagement portion and an integral clip portion, according to the present invention;

FIG. 5 is a perspective bottom view of the assembled knife of FIG. 1, shown in an open state, according to the invention;

FIG. 6 is a left-side perspective assembly view of the blade holder section of the knife of FIG. 1, showing a main jaw, a cover jaw and a slider, according to the present invention;

FIG. 7 is a right-side perspective assembly view of the blade holder section of the knife of the present invention;

FIG. 8 is a perspective view of an assembled and open blade holder section of the knife of FIG. 1, showing the cover jaw located in an open position and a utility blade located within a recess of the main jaw, according to the invention;

FIG. 9 is a perspective view of the assembled blade holder section of FIG. 8, showing the cover jaw located in an intermediate position (between the open position of FIG. 8 and a closed position, according to the present invention;

FIG. 10 is a perspective view of the assembled blade holder section of FIG. 9, showing the cover jaw located in the completely closed position and showing a slider located in an unlocked position, according to the invention;

FIG. 11 is a perspective view of the assembled blade holder section of FIG. 10, showing the cover jaw located in the completely closed position and showing a slider located in a locked position, according to the invention;

FIG. 12 is a perspective front view of the closed and locked blade holder section of FIG. 11, according to the invention;

FIG. 13 is a rear perspective view of the closed and locked blade holder section of FIG. 12, showing details of a locking notch used to interact with an engagement portion of the liner/clip of FIG. 4, according to the invention;

FIG. 14 is a partial enlarged perspective view of the liner/clip showing the engagement portion locked into engagement with the locking notch of the blade holder section (the handle section is not shown in this figure), according to the invention;

FIG. 15 is a side perspective view of the assembled knife of FIG. 5, shown with main jaw and cover jaw located in an unlocked and open position during insertion (or removal) of a utility blade and showing blade holder located in an unlocked position with respect to the liner/clip, according to the invention;

FIG. 16 is a right-side perspective view of the assembled knife of FIG. 5, shown with blade holder located in a stowed position within the handle, according to the invention;

FIG. 17 is a top perspective view of the assembled knife of FIG. 5, showing details of a logo being displayed through an opening of the handle and details of the clip portion of the liner/clip located outside and against a side of the handle, according to the invention;

FIG. 18 is a top plan view of the liner/clip of FIG. 4, according to the invention;

FIG. 19 is a partial perspective view of the blade holder of FIG. 10, showing details of a locking notch that includes a stop wall, according to another embodiment of the invention;

FIG. 20 is a perspective view of a folding knife, according to another embodiment, showing a blade holder and blade in an open and locked position;

FIG. 21 is a perspective view of the folding knife of FIG. 20 shown in a closed position wherein the blade holder and blade are located within a handle, according to this embodiment of the invention;

FIG. 22 is a side view of the folding knife of FIG. 20, showing details of the handle, blade holder, and blade, according to this embodiment of the invention;

FIG. 23 is a perspective view of the blade holder and blade located in an open and unlocked position, showing the blade being inserted (or removed) from the hold of the blade holders, according to the embodiment of this invention;

FIG. 24 is an enlarged partial view of the blade holders, according to this embodiment of the invention, showing details of a ratchet mechanism used to angularly lock the blade holders together in a locked position;

FIG. 25 is an enlarged partial view of the blade holders, according to the embodiment of this invention, showing details of lower blade-capturing arms of a cover jaw and arcuate channels of a main jaw that are sized and shaped to snugly receive the arms, wherein cover jaw is partially open with respect to main jaw;

FIG. 26 is a perspective view of the cover jaw, according to this embodiment of the invention, showing a spring-biased ratchet arm and lower blade-capturing arms;

FIG. 27 is a perspective partial view of the folding knife according to this embodiment showing the cover jaw open with respect to main jaw and main jaw open with respect to the handle, during blade changing;

FIG. 28 is a perspective partial view of the folding knife of FIG. 27 showing details of the opposite side of the blade holder to that of FIG. 27 and wherein a blade is in a seated position between cover jaw and main jaw and cover jaw is almost closed with respect to main jaw, according to this embodiment of the invention;

FIG. 29 is a perspective view of the blade holder assembly (cover jaw and main jaw) in the locked position (blade not shown), showing details of the ratchet locking mechanism and upper and lower blade-capturing arms, according to this embodiment of the invention;

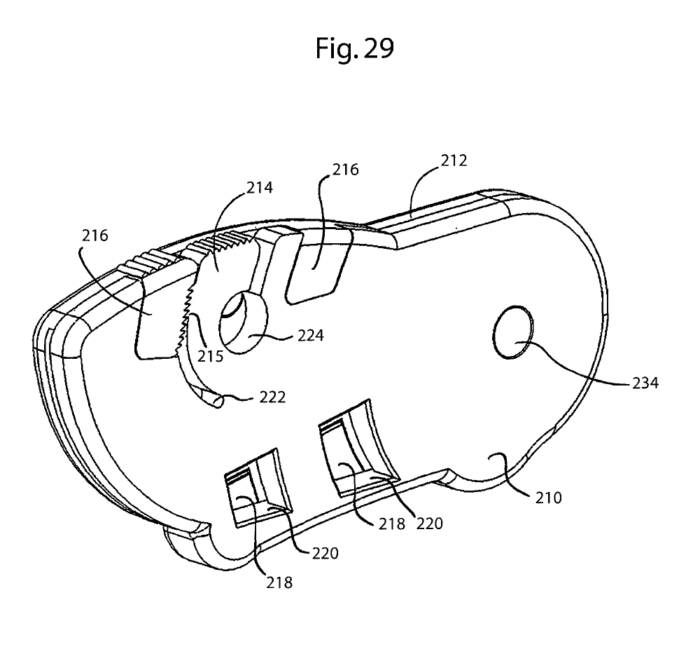

FIG. 30 is a perspective partial view of the folding knife shown in FIG. 28, showing cover jaw partially open with respect to main jaw and also showing details of the ratchet locking mechanism (ratchet teeth just beginning to engage with each other), according to this embodiment of the invention;

FIG. 31 is a side partial view of the folding knife of FIG. 30, according to this embodiment of the invention;

FIG. 32 is a perspective view of the blade holders, shown in their locked position and showing details of the locking region of the tang and a wall that holds an engagement end of liner lock, not shown;

FIG. 33 is a side view of an outer side of the cover jaw, according to this embodiment of the invention;

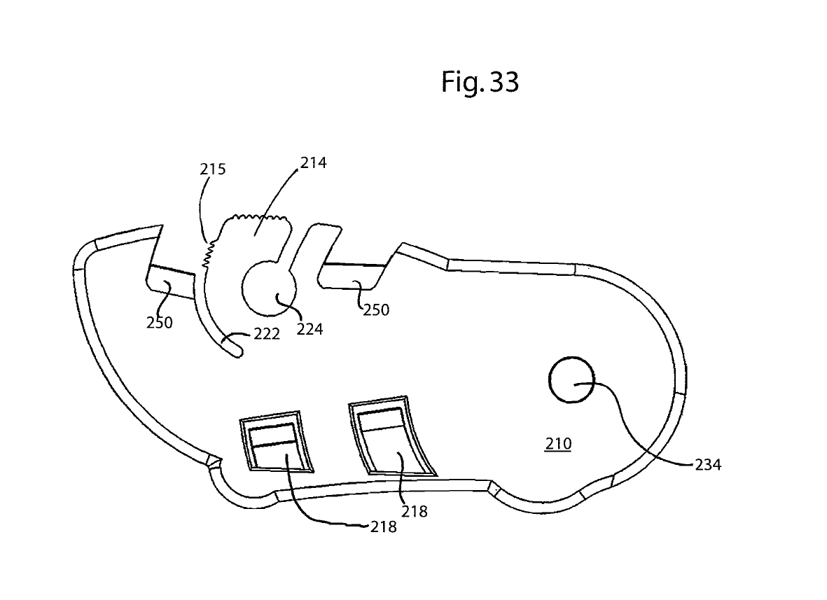

FIG. 34 is a perspective view of an outer side of main jaw, according to this embodiment of the invention, showing details of the arcuate channels;

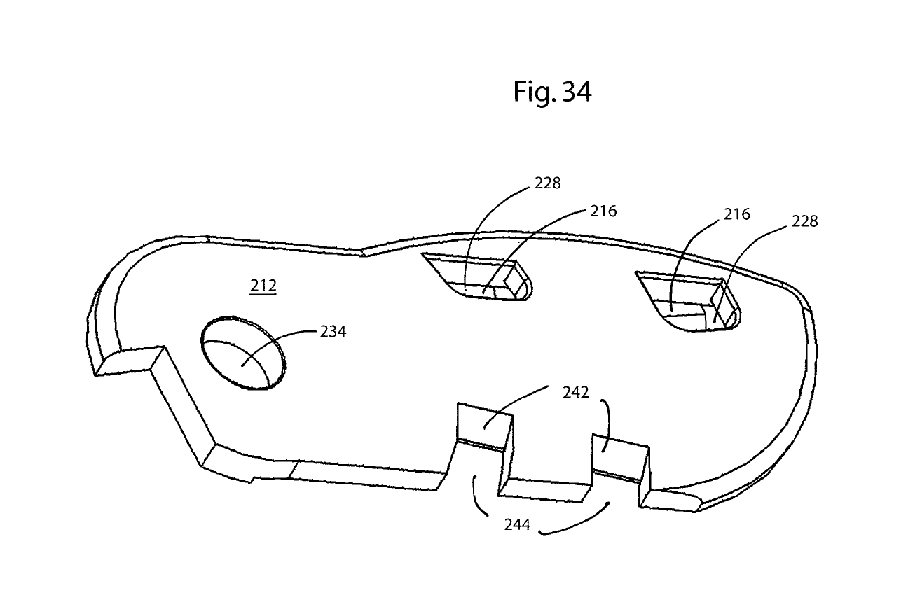

FIG. 35 is a plan view of outer surface of main jaw of FIG. 34, according to this embodiment of the invention;

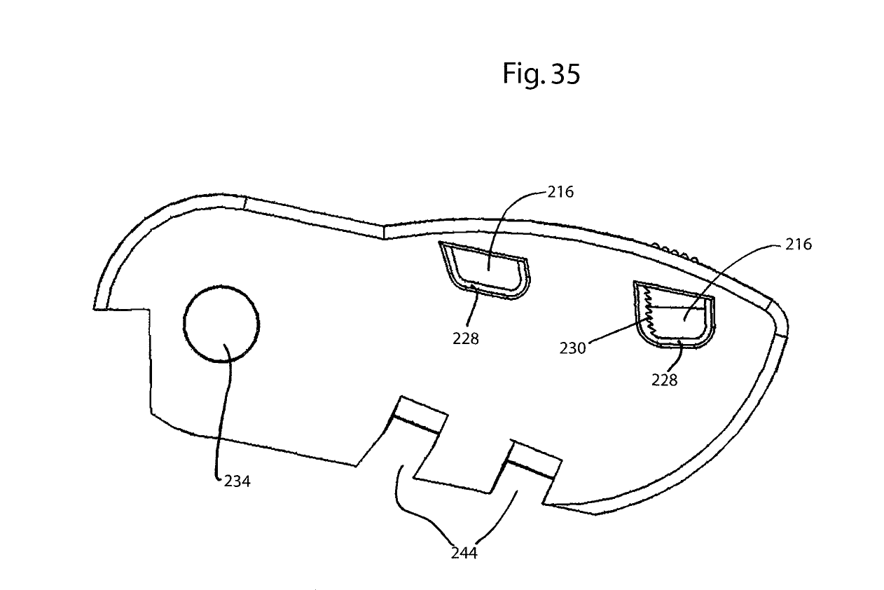

FIG. 36 is a perspective view of an inner surface of the main jaw, showing details of the upper blade-capturing arms, a notch-receiving post, and lower arcuate channels, according to this embodiment of the invention;

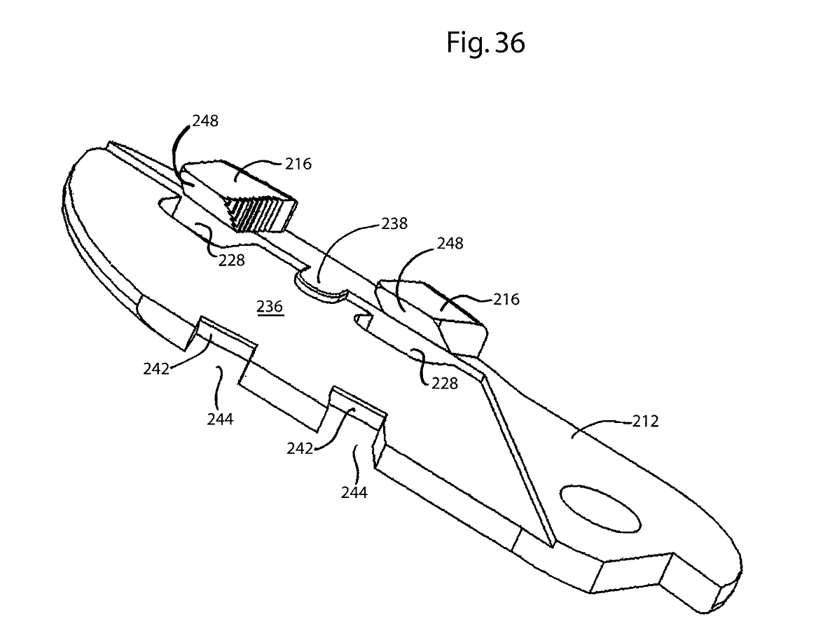

FIG. 37 is another perspective view of main jaw of FIG. 36 showing a different angled view of the inner surface, according to this embodiment of the invention; and

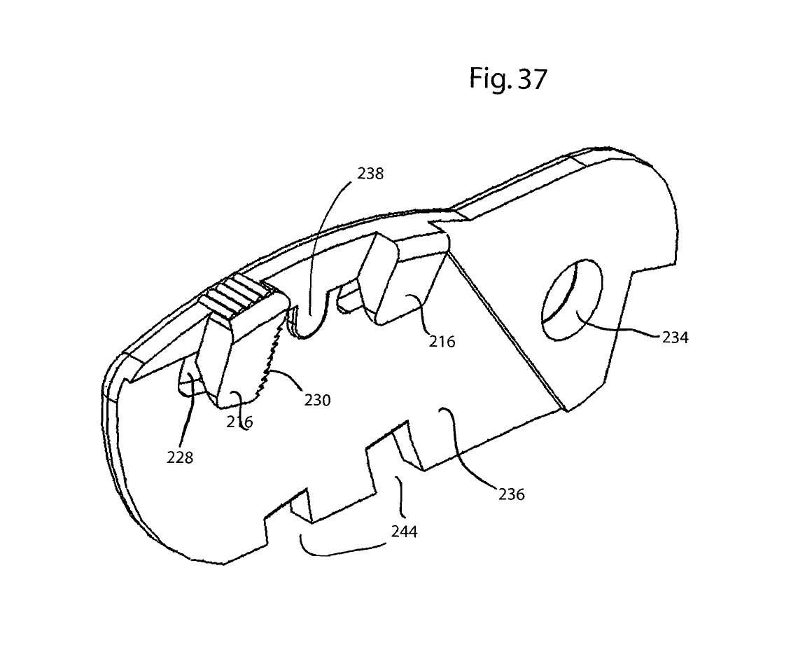

FIG. 38 is a plan view of the inner surface of the main jaw, according to this embodiment of the invention.

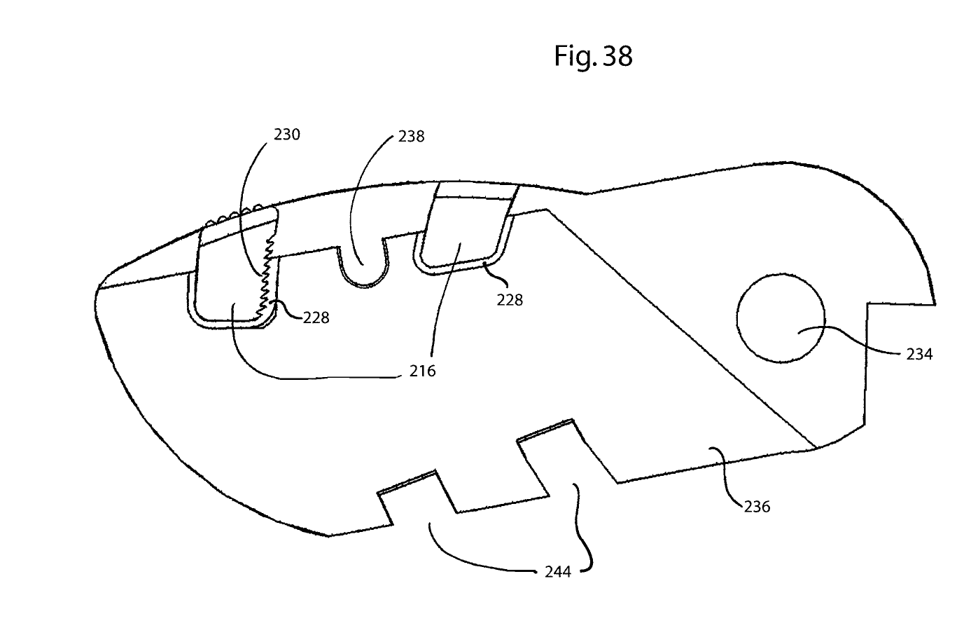

### DETAILED DESCRIPTION OF THE PREFERRED EMBODIMENTS

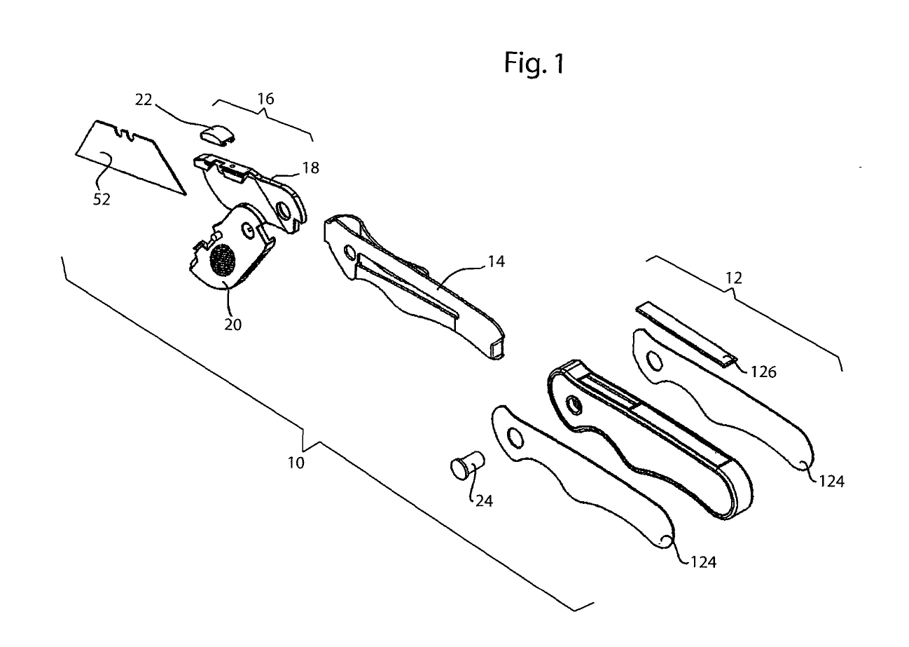

Referring to FIG. 1, there are three main sections to the present knife 10 (not including the blade), a handle assembly 12, a liner/clip 14, and a blade holder assembly 16. The blade holder assembly 16 includes a main jaw 18, a cover jaw 20, and a slider 22. A pivot pin 24 is used to connect blade holder assembly 16 and liner/clip 14 to the handle 12 in a pivotal manner, as described below.

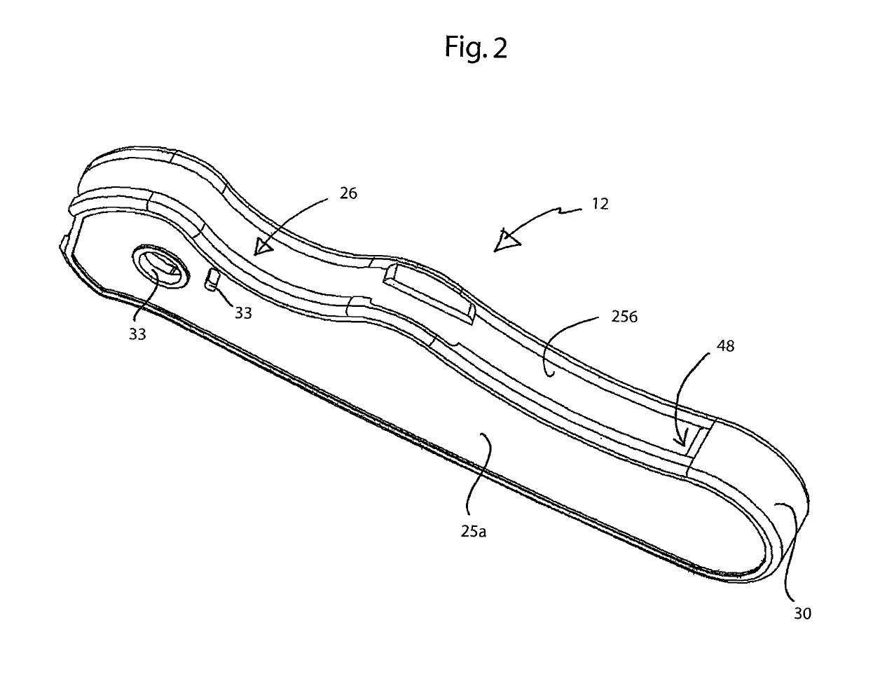

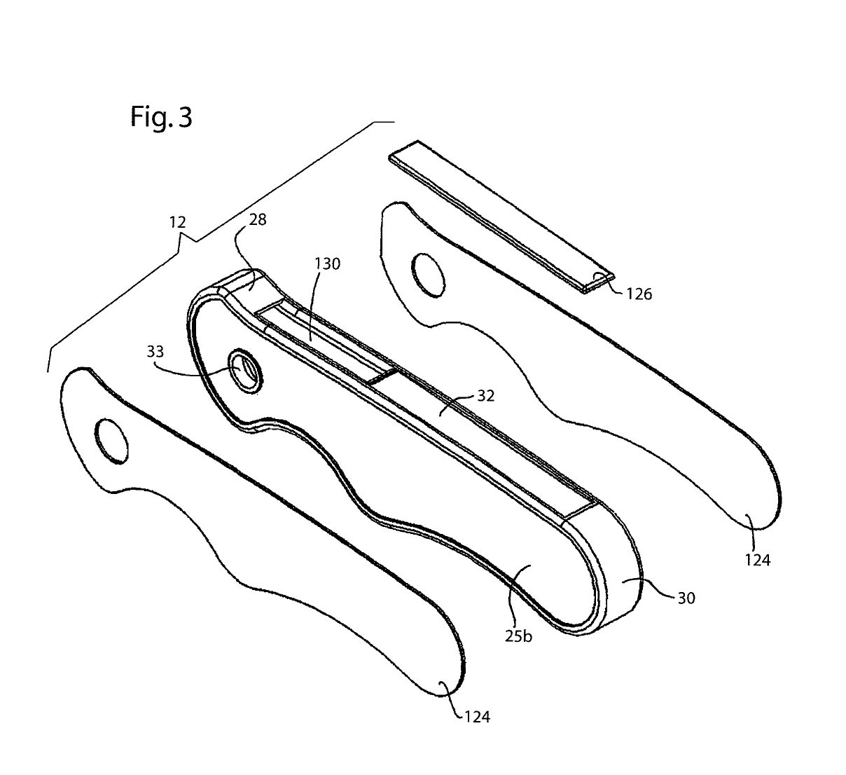

Referring now to FIGS. 2 and 3, handle 12 includes two sides 25a, 25b, which are spaced apart to define an interposed cavity 26 into which blade holder assembly 16 can reside, when stowed. Both sides 25a, 25b are connected to each other by a front portion 28, a rear portion 30 and a top portion 32, all of which are preferably formed integrally as a single molded piece of an appropriate strong plastic, such as reinforced nylon. Handle 12 also includes a bore 33 that is sized and shaped to receive pivot pin 24 (which holds a majority of the parts of the present knife together and allows the blade holder assembly 16 to pivot, as described below).

Although a single plastic injection molded part is preferred in this invention, the individual sections of the handle 12, identified above, can also be provided as separate parts and be secured to each other by using an appropriate adhesive or fasteners, as is well understood in the art. However, the gist of the present invention is to provide a low-cost, easy-to-assemble knife and therefore, a single integrally-formed handle assembly is more appropriate for the preferred embodiment being described.

Regardless whether the handle 12 is made integrally as a single part, or as an assembly of separate components, any material can be used, such as plastic, carbon-fiber, wood, metal, or other composite materials or laminates.

As described in greater detail below, all the parts are designed to “snap” together, fit within handle 12, and finally be held together by pivot pin 24. The present knife is easy to assemble, required few parts to manufacture and yet can safely and securely hold a razor blade for use as a foldable utility type knife.

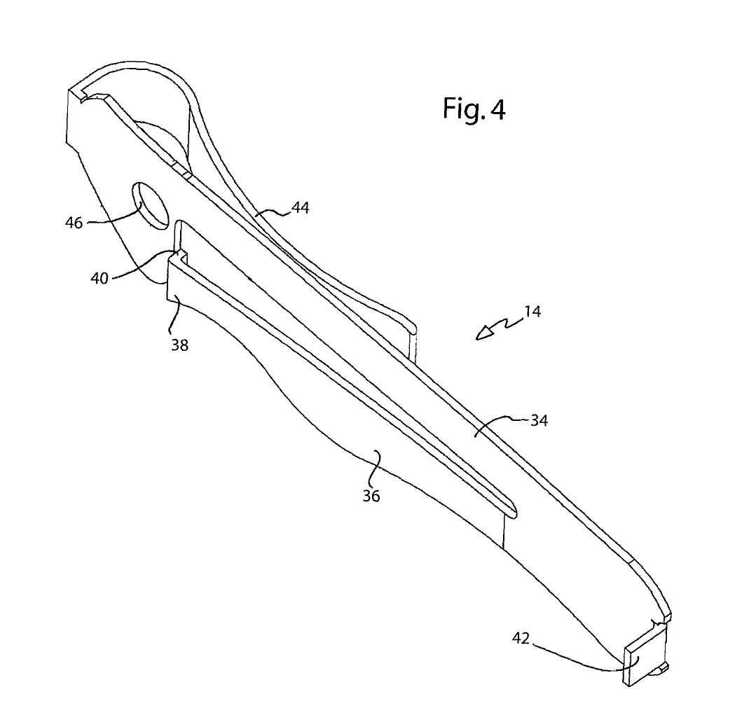

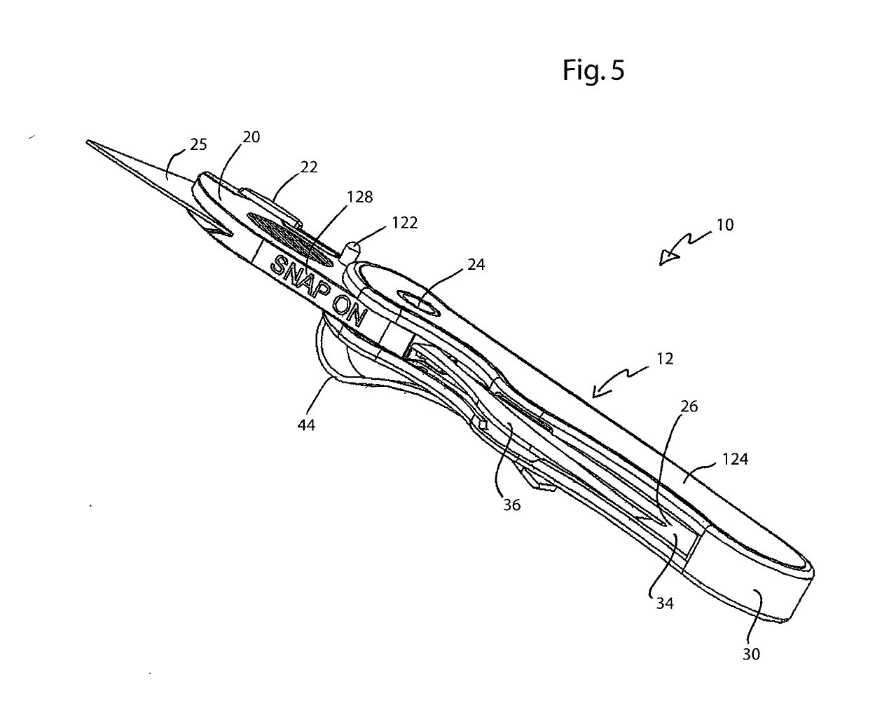

Referring to FIGS. 4 and 5, liner/clip 14 includes a body 34, a spring arm 36 which has an engagement end 38 with an L-bend 40, a spacer tab 42 and a clip 44. Body 34 includes a bore 46 that is sized, shaped and positioned to align with bore 33 of handle 12 when liner/clip 14 is properly assembly within cavity 26. Liner/clip 14 is preferably integrally made from steel, as a single unit, using known metal forming methods including bending, stamp-cutting and shaping, so that the clip 44 is formed directly attached to body 34. Typically, the clip of a conventional knife is secured to the outside handle using two or three screws. The conventional clip and the clip of the present invention both serve the function of allowing a user to hold the knife to a belt or pocket for quick and easy access, but the clip and liner of the present invention are conveniently formed as a single part. As can be appreciated by those skilled in the art, combining the clip and the liner helps during the assembly of the knife at the factory because there will be fewer parts to manufacture, handle, and assemble.

Liner/clip 14 is sized and shaped to snugly fit within the cavity 26 of handle assembly 12 so that liner body 34 becomes positioned immediately adjacent to and flush with an inner surface of side wall 25a, within the cavity 26. Liner/clip 14 is preferably seated within a shaped recess 47 (see FIG. 5) located within an inside wall surface of cavity 26 so that the width of cavity 26 can be close to the combined width main jaw 18 and cover jaw 20. Furthermore, as mentioned above, liner/clip 14 is positioned within cavity 26 so that bore 46 of handle assembly 12 aligns with bore 33 of liner 14.

Spacer tab 42 of liner/clip 14 can be formed as a simple bend in body 36 and is sized and shaped to extend across the handle cavity 26 to help hold the liner/clip 14 in place within the cavity 26. Cavity 26 of handle 12 preferably also includes a pocket 48 (or undercut) formed at the rear end 30 which effectively further holds the liner/clip 14 in place (against rotational displacement about pivot pin 24). This arrangement obviates the need to use additional fasteners to hold the liner/clip 14 in place (as is typically the case with conventional liners of conventional knives). Of course additional fasteners can be used if the design and size of the particular knife requires them, but again, the preferred knife of the present invention is meant to be as simple as possible. The construction of the handle 12 and liner/clip thus described allows the liner/clip to be quickly inserted within cavity 26 of handle 12 in such a manner that positions clip portion 44 outside the handle 12 and positions body 34 within cavity 26 until spacer tab 42 is positioned within cavity 26 under pocket 48, greatly simplifying assembly.

Referring now to FIGS. 1, 6 and 7, blade-holder assembly 16 is shown including main jaw 18 and cover jaw 20. Both jaws are pivotally mounted about pivot pin 24 so that both may pivot together, when locked by slider 22 (as described below). When slider 22 is moved to an unlocked position, cover jaw 20 can then selectively pivot with respect to main jaw 18. As described in greater detail below, when the two jaws are angularly displaced with respect to each other, a blade can then be inserted or removed.

Main jaw 18 and cover jaw 20 can be made from an appropriate metal, such as steel or aluminum, but it is preferred that an appropriate strong, durable, somewhat resilient plastic is used instead since plastic is easier to mold and cheaper and lighter.

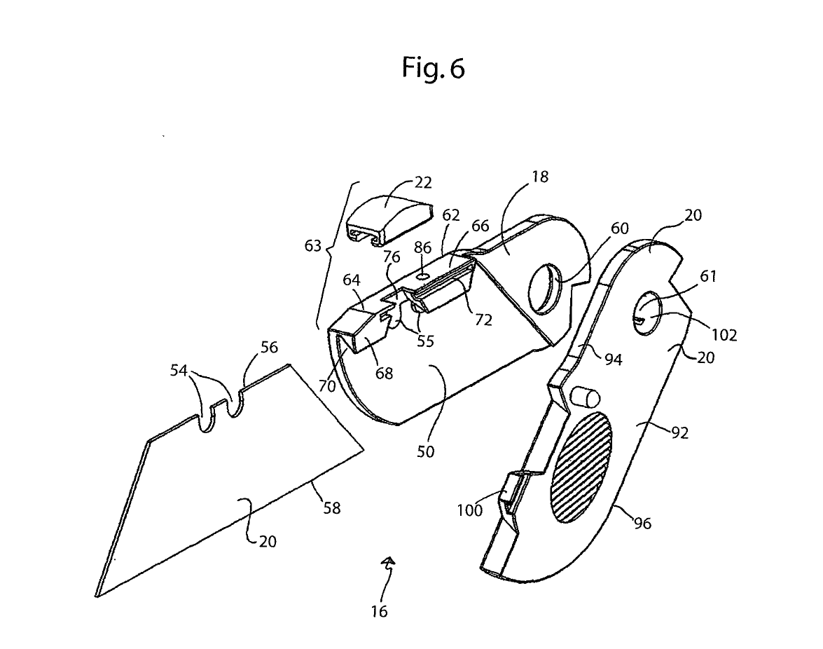

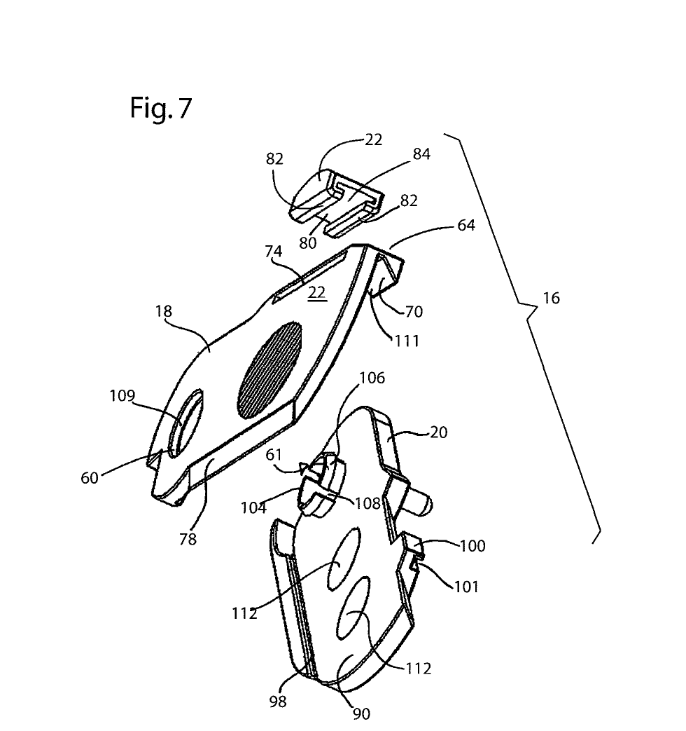

As shown in FIGS. 6 and 7, main jaw 18 is generally planar and includes an inside blade recess 50 which is closely shaped to the plan-view shape of a conventional trapezoidal razor blade 52 (of the type that includes two notches 54 along its top edge 56 and includes a sharpened bottom edge 58). Recess 50 has a depth that is preferably equal to (or slightly less than) the thickness of the razor blade (standard utility type razor blades are about 0.6 mm thick) and includes at least one, but preferably two notch-receiving posts 55 which are sized, shaped and positioned to snugly receive notches 54 of an inserted blade located along the top edge 56 of these conventional razor blades 52. Recess 50 is designed to hold a trapezoidal razor blade 52 so that a portion of the blade extends beyond the recess 50 and beyond blade holder assembly 16 so that a portion of the sharpened edge 58 can be used to cut material.

Main jaw 18 further includes a bore 60 that is sized and shaped to snugly receive pivot pin 24 during assembly. As described below, bore 60 is also shaped to receive a snap connection assembly 61 of cover jaw 20. Located along an upper edge 62 of main jaw 18 is a slider-lock assembly 63 which includes a wall 64 that defines a top surface 66, an outside surface 68 and an inside locking channel 70.

As shown in FIGS. 6 and 7, a first slider channel 72 is provided, formed within the outside surface 68 of wall 64. A second slider channel 74 is provided along an outer face 75 of main jaw 18 (see FIG. 7). First and second slider channels 72 and 74 are elongated channels that are adapted to receive portions of slider 22, as described below.

Wall 64 includes a generally trapezoidal-shaped cutout 76 which intersects first slider channel 72 (forming a break in the otherwise continuous channel). The function of cutout 76 of wall 64 is described below.

Main jaw 18 further includes a beveled lower edge 78 which is positioned to reside adjacent to the sharpened bottom edge 58 of blade 52 when the blade is positioned (mounted) within recess 50. The function of this beveled lower edge 78 is to engage with a mating feature of cover jaw 20 and thereby hold an interposed blade more tightly, as described in greater detail below. Slider 22 is a clip-like component that is used to selectively lock main jaw 18 to cover jaw 20, as described below. Slider 22 includes a bottom surface 80 and opposing rail-like edges 82 that are turned inwardly towards each other, defining a sliding channel 84 therebetween. Rail-like edges 82 are designed to be slidably received within first and second slider channels 72, 74 so that slider 22 can selectively slide by movement of a user's thumb, for example, back and forth to the extent that the slider channels 72 and 74 allow.

Slider 22 is slidably connected to main jaw 18 within slider channels 72, 74 so that slider 22 can move along the top surface 66 of wall 64 between a locking position (which is preferably forward—towards the tip of the blade) and a releasing position. As shown in FIG. 6, a locking detent 86 helps hold slider 22 in its locked position. Slider 22 preferably remains slidably connected to main jaw 18 and only selectively mechanically engages with and effectively locks to cover jaw 20, when desired. Also, as the present knife is being used, a user's thumb will naturally rest on slider 22 and further force it forward to the locked position. Both of these features (detent 86 and the position of the user's thumb) will help prevent the blade from accidentally slipping from its grip within blade holder 22, but, as described below, even if the slider 22 does move to its releasing position, the held blade will remain securely held until the liner lock 14 is moved to an unlocked position.

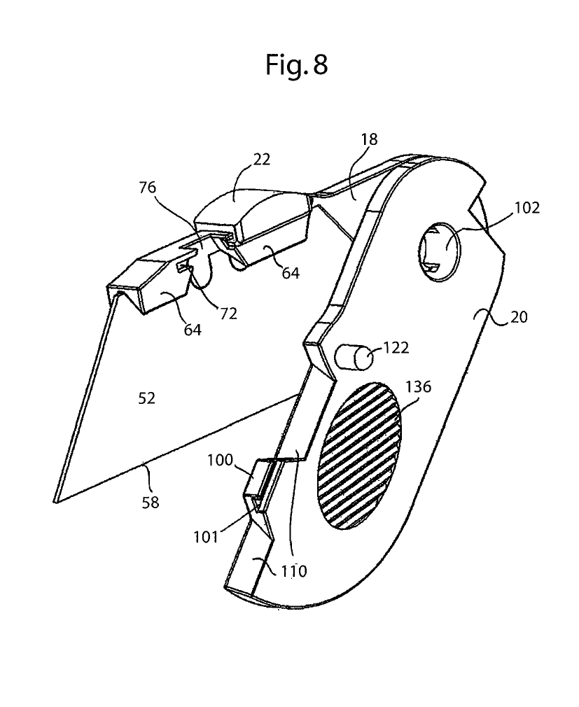

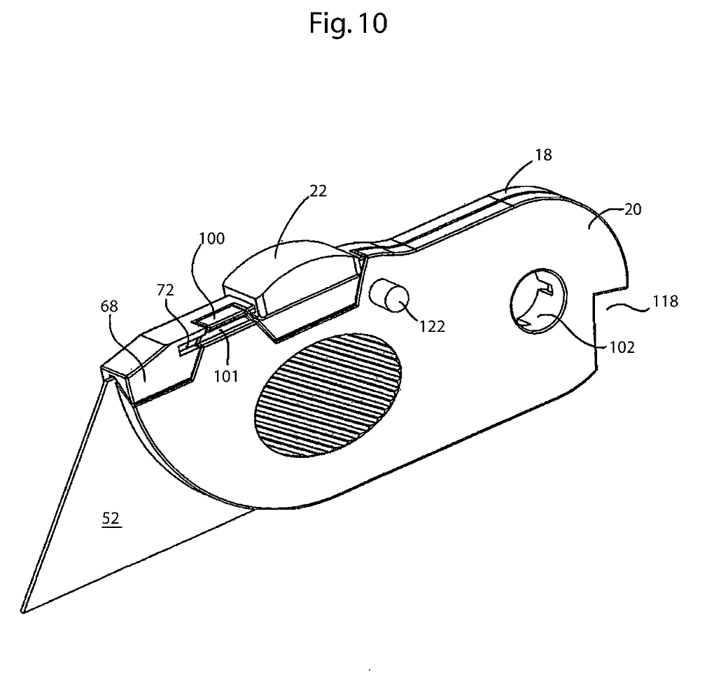

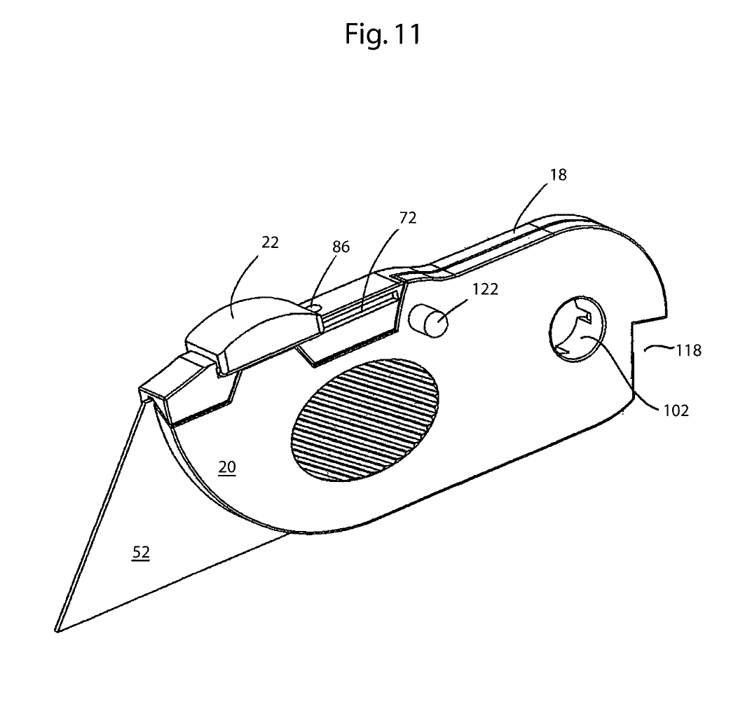

Continuing with FIGS. 6 and 7, cover jaw 20 is shown including an inside surface 90, an outside surface 92, a top edge 94, a bottom edge 96 shaped to define an upwardly directed channel 98 (running the length of the bottom edge 96), a top projection 100, a slider channel 101, a bore 102 and a pivoting snap collar 104. Cover jaw 20 is designed to snap-lock to main jaw 18 so that cover jaw is allowed limited pivotal movement with respect to main jaw, (when all slider lock and liner lock have both been released). Cover jaw 18 can pivot between a blade-accessible orientation, as shown in FIG. 8, and a blade-captured orientation, as shown in FIG. 10 (unlocked) and FIG. 11 (locked). As shown in FIG. 7, annular snap collar 104 is sized and shaped to snap into bore 60 of main jaw 18 so that the two jaws can become pivotally connected. Snap collar 104 which can be conventional and is generally known in the art, includes arrow-shaped annular locking sections 106, separated by channels 108 that allow each locking section to independently flex. In this manner, snap collar 104 can lock onto an awaiting annular flange 109 located (see FIG. 7) within bore 60 of main jaw 18. Once both jaws 18, 20 are pivotally secured to each other, snap collar 104 retains bore 102 so that the entire blade-holder assembly including cover jaw 20 pivotally connected to main jaw 18 can, in turn, be pivotally secured to handle 12 using pivot pin 24. Alternatively, main jaw 18 and cover jaw 20 do not require snap collar 104 to function. The two jaws just have to include a bore to receive pivot pin 24.

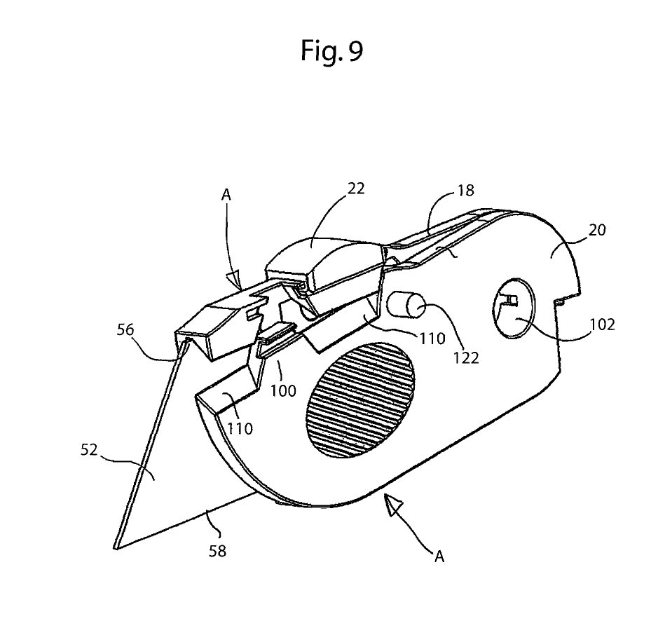

As introduced above, once pivotally connected to main jaw 18, cover jaw 20 can pivot between a blade-accessible position and a blade-capture position. Following the steps of a blade insertion procedure, according to the invention and described below, referring first to FIG. 8, cover jaw 20 is first pivotally opened with respect to main jaw 18 (note that slider lock has been moved to the released position). Once the jaws are pivotally separated, recess 50 becomes exposed and accessible to the user and a blade 52 may be positioned within recess 50 so that notches 54 of the blade can be aligned with posts 55 (the blade is shown aligned within recess 50 in FIG. 8). When a blade is positioned in recess 50, the user may then squeeze the two jaws closed (in the direction of arrows A-A of FIG. 9) so that cover jaw 20 pivots about pin 24 and with respect to main jaw 18.

As the jaws close on the blade 52, upper edge 56 of the blade 52 is safely captured within downwardly-directed channel 70 of main jaw 18, while the lower sharpened edge 58 is safely and securely captured by upwardly-directed channel 98 of cover jaw 20. As shown in FIG. 9, as the two jaws close, projection 100 of cover jaw 20 is shaped and positioned to be snugly received by trapezoidal-shaped cutout 76 of main jaw 18. Also, select beveled portions 110 of upper edge 94 of cover jaw 20 are shaped and positioned to also become captured by channel 70 of main jaw 18. This interaction causes cover jaw 20 and main jaw 18 to press tightly against each other and thereby tightly hold blade 52, when cover jaw 20 is finally closed with respect to main jaw 18, as shown in FIGS. 10 and 11. Similarly, and somewhat symmetrically, beveled lower edge 78 is positioned to be received by channel 98 which further presses the two jaws laterally towards each other and against the blade 52.

Once the two jaws are in their closed position (as shown in FIGS. 10 and 11), the blade 52 is secured within recess 50 and cannot be pulled or wiggled from the grip of the jaws 18, 20. The blade cannot be pulled out because posts 55 are engaged within notches 54 of blade 52. Also, the jaws cannot be easily pried apart since beveled edges 110 and 78 are locked within channels 70 and 98, respectively.

As a final step to the insertion process, the two jaws are locked in their closed position (thereby giving the blade holder 16 some integral strength) by moving slider 22 from its released position (shown in FIG. 10) to its locked position (shown in FIG. 11). This is done simply by linearly displacing slider 22 towards the tip of the blade 52, overcoming the mechanical friction of detent 86 and also any friction between rails 82 and channels 72, 74. As is apparent in FIGS. 10 and 11, when slider 22 is moved into its locking position (FIG. 11), rails 82 engage both channel 70 of main jaw 18 and slider channel 101 of projection 100 of cover jaw 20. Slider 22 is long enough to engage channel sections 70 on BOTH sides of cutout 76 of wall 64 of main jaw 18 and the entire channel 101 of cover jaw 20. This overlapping relationship of channels and rails of slider 22 effectively pivotally lock cover jaw and main jaw together and also help hold cover jaw 20 tightly laterally against main jaw 18.

Slider 22 can be made from an appropriate plastic or metal. In either case, depending on the particularly of the design, slider 22 can be snapped into place into the channels during assembly and thereafter cannot be removed, but only may now slide within channels. If slider is made from metal, Applicant contemplates clinching slider 22 around main jaw 18 so that its pre-formed rails enter into and remain within the channels 72, 74 of main jaw 18.

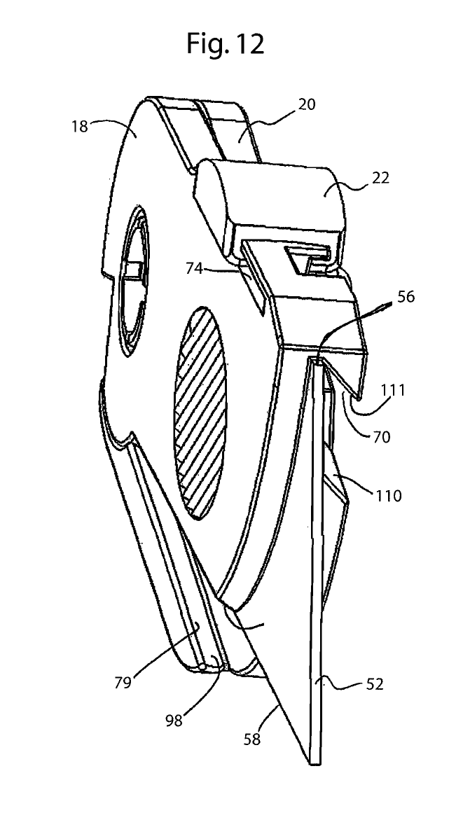

Referring to FIG. 12, cover jaw 20 is shown (from a front view) being pivotally closed into locking engagement with respect to main jaw 18. This figure illustrates how upper edge 56 of blade 52 is safely captured by channel 70 of main jaw 18 and how lower edge of blade 52 is similarly captured by channel 98 of cover jaw 20. Both channels 70, 98 are preferably shaped with an inside beveled face 111, 79, respectively, so that they can readily and tightly receive the beveled edges 110 of cover jaw 20 and beveled lower edge 78 of main jaw 18, as described above.

Referring back to FIG. 7, cover jaw 20 can further include shallow dome-like bumps 112 located on the inner surface 90. These bumps can be shaped and positioned in a variety of ways and serve to further push cover jaw 20 against blade 52, effectively taking up any slack that may exist with certain thinner blades.

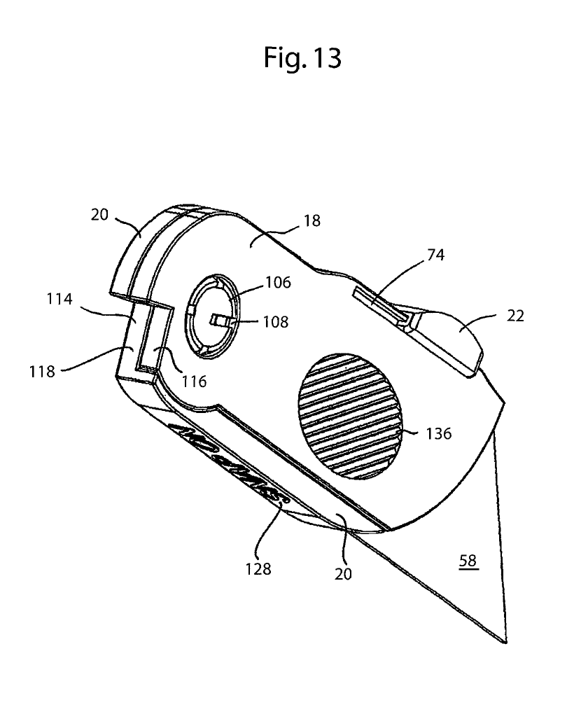

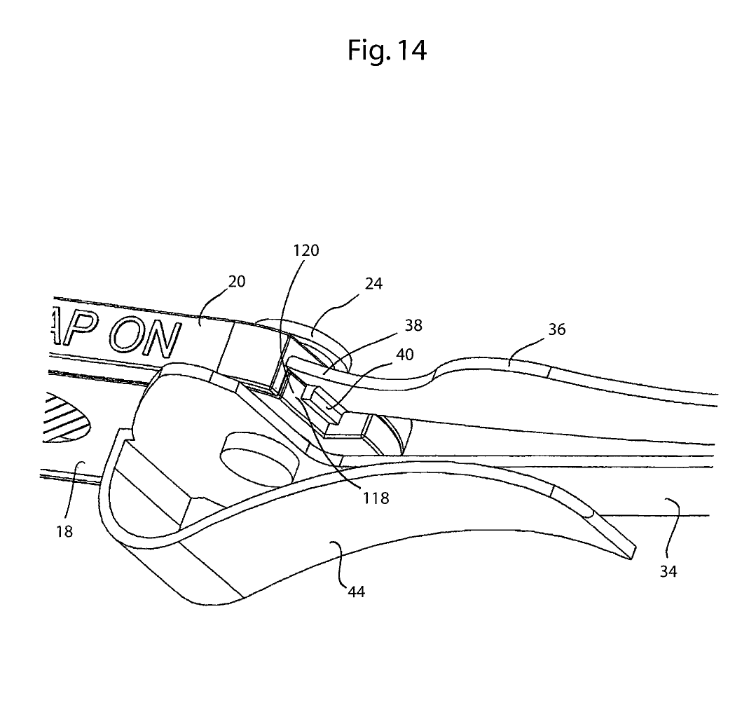

Referring now to FIG. 13, the rear portion of a closed and locked blade-holding assembly 16 is shown. As can be seen in the figure, cover jaw 20 and main jaw 18 both include locking notches 114, 116, respectively, on their respective back-ends, which come together and align to form a single common locking notch 118, when the two jaws are in their fully closed position. This combined locking notch 118 is used to engage with engagement end 38 of spring arm 36 of liner lock 14, when the blade holder is pivoted to the open and locked position. This engagement with liner lock 14 is illustrated in FIG. 14, wherein handle assembly is not shown (for clarity). The operation of liner lock 14 is well known by those skilled in the art and is therefore not described in great detail in this application. However, the liner lock of the present invention includes an improved feature, L-shaped L-bend 40. This allows engagement end 38 to be wider and engage a larger surface of locking notch 118.

When the blade holder assembly 16 is opened to a locked and fully open position (with the blade and both jaws locked in a closed position), engagement end 38 of spring arm 36 of liner lock 14 will automatically move (by the action of the inherent spring bias of spring arm) into locking engagement with locking notch 118, when the locking notch aligns with the engagement end 38. The spring action of the spring arm 36 will force engagement end 38 to move across the space 26 of handle 12 immediately adjacent to locking notch 118 until L-bend 40 binds into locking mechanical engagement with locking notch 118, thereby securely holding blade holder assembly 16 into the fully open position. The locking notch 118 may include an appropriately curved or slanted face 120 to promote a tight engagement with L-bend 40.

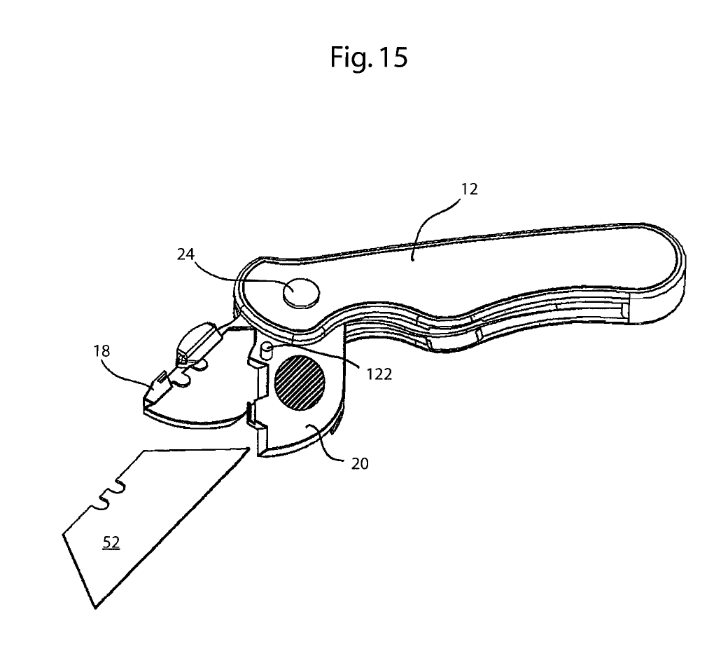

Engagement of engagement end 38 of liner lock 14 further serves to prevent main jaw 18 and cover jaw 20 from pivoting with respect to each other whenever the blade-holder 16 is positioned in its fully opened and locked position (as shown in FIG. 14). Therefore, according to an embodiment of this invention, in order to release (or install) a blade 52 from blade holder 16, engagement end 38 of liner lock 14 must be forced against its spring bias so that engagement end 38 (and L-bend 40) moves out of overlapping engagement with locking notch 118, thereby releasing blade holder 16 and allowing the same to pivot about pin 24, if desired. As shown in FIG. 15, when blade holder assembly 16 is unlocked from the liner lock, as just described, cover jaw 20 can then (and only then) be pivotally displaced with respect to main jaw 18. With this arrangement, the liner lock provides additional safety in keeping the blade of the present invention securely held within blade holder 16 until it is desired to remove the blade.

As shown in FIGS. 9 and 15 (and other figures), a thumb-peg 122 may be provided, attached to (or integrally molded into) either main jaw 18, cover jaw 20, or both. As is well known by those skilled in the art, the thumb-peg 122 can be used to help the user quickly and easily open “the blade” (actually, the blade-holder assembly 16 and the blade 52). This peg 122 is shown as an exemplary peg. Other structures can be used to serve the same function without departing from the present invention.

Referring back to FIG. 1, the assembly of the present knife 10 is illustrated. The present knife is made using few parts so that it can be assembled quickly and easily. To assemble the present knife:

1) Snap main jaw 18 to cover jaw 20 by snapping snap-connection assembly 61;

2) Position slider 22 into sliding engagement with the slider channels 72, 74;

3) Position liner/clip 14 into cavity 26 of handle 12 so that bore 46 aligns with bore 33;

4) Insert the assembled blade holder 16 into cavity 26 of handle 12 so that bore 102 aligns with bore 33 of handle 12;

5) Insert pivot pin 24 into aligned bores 33, 102 and 46; and

the assembly of the basic knife, according to the present invention is complete.

As mentioned above, according to the invention, knife assembly 12 can be made as a single piece of metal (such as aluminum or steel), plastic through injection molding, or even wood. Also, as mentioned above, handle assembly 12 can be made as a single piece of material or made from several pieces that are secured together using an appropriate adhesive or fastener. According to yet another feature of the present invention, as shown in FIG. 1, handle 12 can also include side panels 124 and top panel 126. Such panels can be decorative or functional serving, for example, as a cushioned surface. Panels are preferably made from rubber and, if handle 12 is made plastic, panels are preferably attached to handle using an over-molding process wherein a plastic formed part is re-inserted into another mold into which rubber is injected to form the panels 124, 126. Panels 124, 126 can be recessed partially or wholly within appropriate recesses of handle 12.

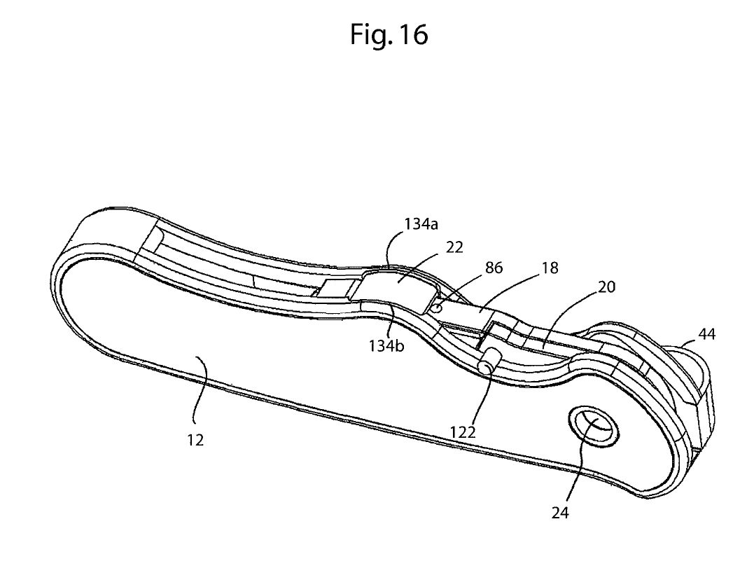

As shown in FIGS. 5 and 16, blade holder 16 is pivotal between a fully open and locked position for use (shown in FIG. 5) and a fully closed position (shown in FIG. 16). Like conventional knives, a user can use thumb pin 122 to open and close the knife between the two positions so that only a single hand is required.

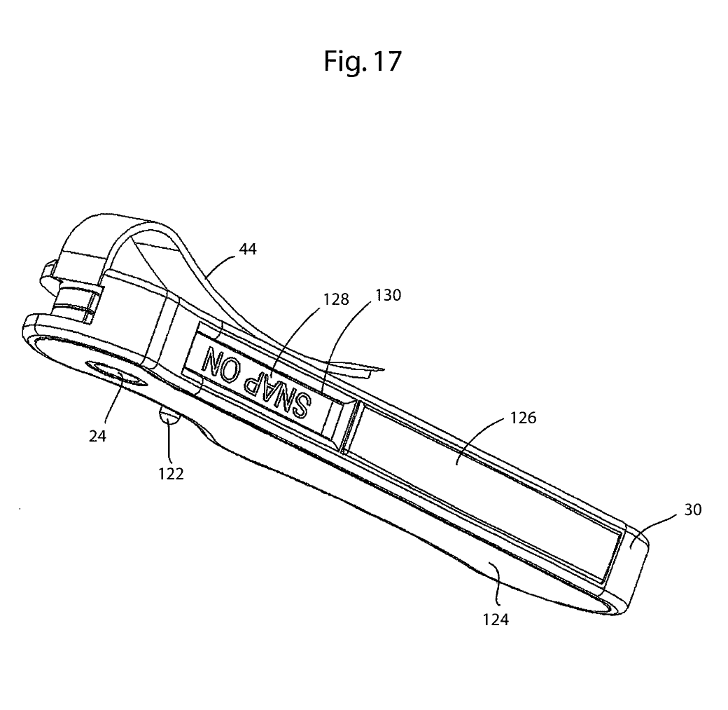

According to another aspect of the present invention, a logo 128 (or design or text—for example, “SNAP-ON” is shown in the figures) is provided on a portion of blade holder 16 (or on the blade itself so that logo 128 can be viewed when blade holder 16 is in the open position, as shown in FIG. 5. As shown in FIGS. 3 and 17, an opening (or viewing window) 130 is provided in handle 12 which is sized and shaped to reveal logo 128 when blade holder 16 is located in its closed position, so that logo 128 can also be viewed when blade holder 16 is closed, as shown in FIG. 17. Although the logo is shown on the lower surface of the cover jaw 20, the logo 128 can equally be located on any side, upper or lower surface of either jaw (or both), and similarly, the viewing window 130 can be positioned anywhere on the handle, including the sides. Logo 128 can be ink printed, laser-etched, or molded into the jaw surfaces.

As shown in FIG. 2, handle 12 can include a slot 132 to accommodate L-bend 40 of liner/clip 14 when engagement end 38 is in its unlocked position, as understood in the art. Also, handle 12 preferably includes a shaped recesses 134a, 134b located along the bottom edges of sides 25a, 25b, respectively. Shaped recesses 134a, 134b are sized and shaped and positioned to receive slider 22 when blade holder 16 is located in its closed position within cavity 26 of knife handle 12, as shown FIG. 16. These recesses 134a and 134b are preferably shaped and positioned to only receive slider 22 when slider 22 is in its locked position with respect to blade holder 16. If slider 22 is not in its locked position, blade holder 16 will not completely close into handle 12, thereby serving as an indicator to the user that the slider 22 is not in its locked position.

As shown in FIGS. 6 and 7, gripping surfaces 136 may be provided on the outer surfaces of both main jaw 18 and cover jaw 20 to aid in opening and closing the jaws, as can be understood by those skilled in the art. Gripping surfaces 136 can be formed integrally in the molding of the jaws and may simply include a raised texture or ribs, or may include a rubber (or other) layer, as desired, adhered or over-molded in place.

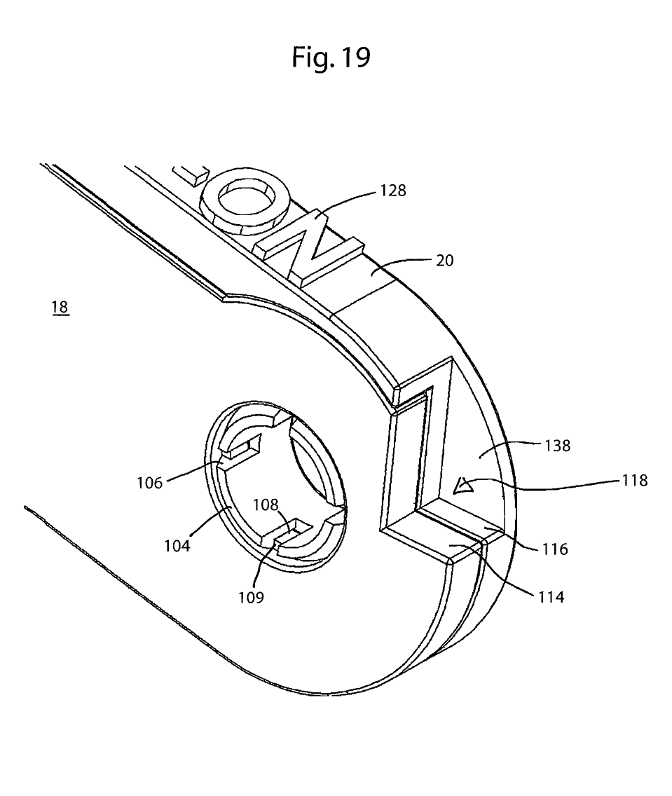

Referring now to FIG. 19, another feature of the present invention is shown wherein a wall 138 is integrally molded to main jaw 20. This wall is used to capture and retain engagement end 38 of liner/clip 14 when blade holder 16 is opened to its fully open and locked position, as shown in FIG. 5. Although this wall 138 is not necessary for the liner/clip 14 to properly lock and hold blade holder 16 in the open position, it would help prevent engagement end 38 from creeping across the combined locking notch 118 and accidentally slipping between blade holder 16 and the inside wall of handle 12, as can be appreciated by those skilled in the art.

Although not shown, Applicant further contemplates alternative locking mechanism to lock cover jaw 20 to main jaw 18 in place of slider 22 and channels 72, 74 and 101. This alternative lock also relies on a mechanical overlapping arrangement and may include a hole located along the top edge of cover jaw aligning with a similar hole located along the top edge of the main jaw. In operation, when the two jaws are located in the closed position (as shown in FIG. 10, the two holes align. At this point, a pin or other projection (not shown) can then be allowed to selectively, or automatically (by spring-bias) enter within the two aligned bores and thereby lock the two jaws together. The pin may be the shaft of a screw or bolt and may be rotatable by the user's fingers. The pin may also serve as the thumb pin 122 (see FIG. 15).

### DETAILED DESCRIPTION OF RATCHET EMBODIMENT

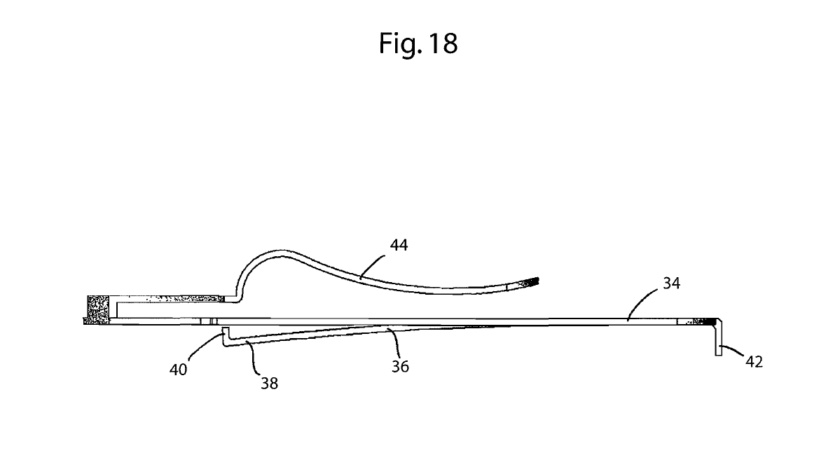

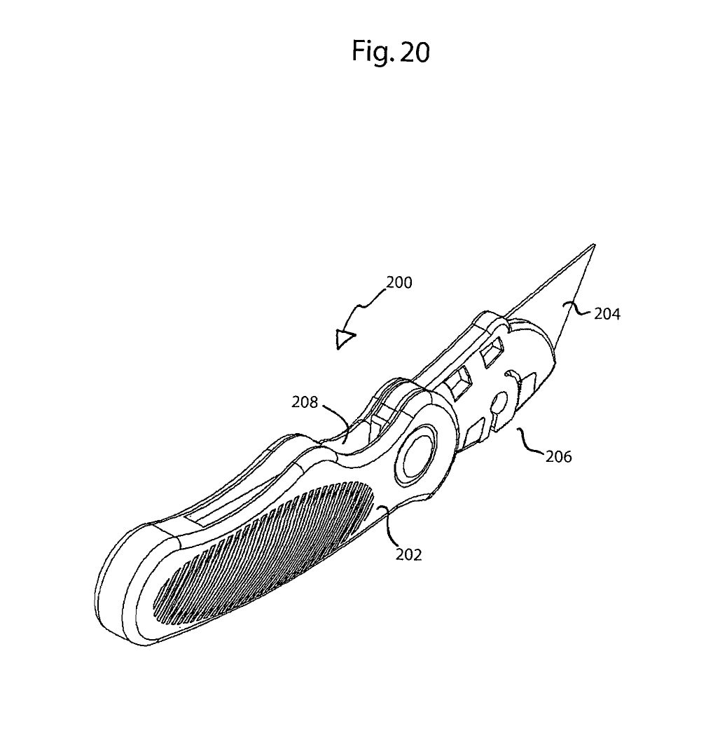

Referring now to FIGS. 20-23, a knife 200 is shown according to another embodiment, including a handle 202, a blade 204, a blade holder 206 and a liner lock 208. Similar to previously-described embodiments of this application, blade holder 206 includes two interlocking parts, a cover jaw 210, and a main jaw 212 and, as in earlier described embodiments (shown in FIGS. 1-19 and described above), both jaws are pivotally connected to each other and to one end of handle 202 (along a pivot axis A) so that cover jaw 210 can pivot with respect to main jaw 212, when desired. Also, both jaws when locked together can pivot with respect to handle 202, as is understood from the above description of earlier embodiments of this invention.

As will become apparent, this presently described embodiment of knife 200 has an important improvement over the earlier knife embodiments described above and shown in FIGS. 1-19. In this present embodiment, knife 200 does not require slider 22 to lock cover jaw 210 to main jaw 212 in the blade-holding process. This embodiment saves one part and therefore offers a knife product that is easier to make, assemble and repair, if necessary. Also, the fewer the parts needed, the lower the chance of operational failure of the knife in use.

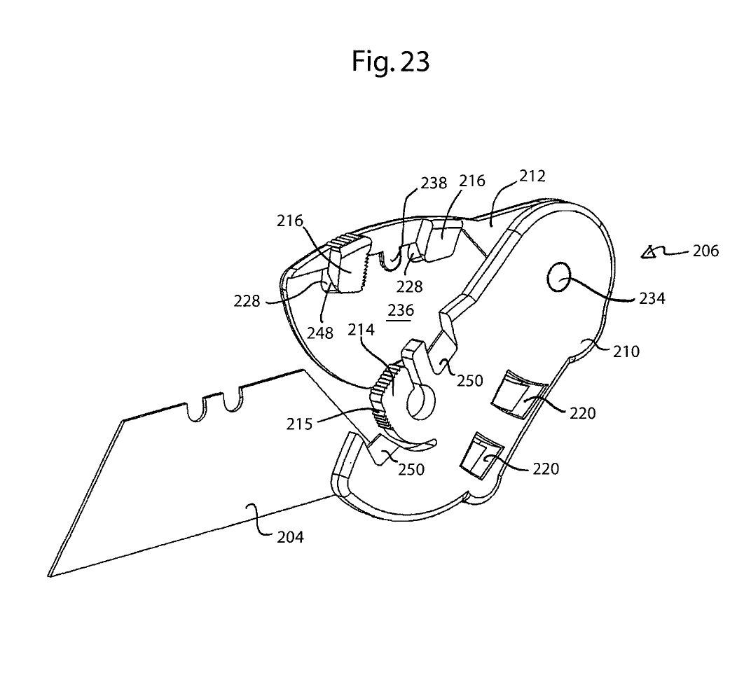

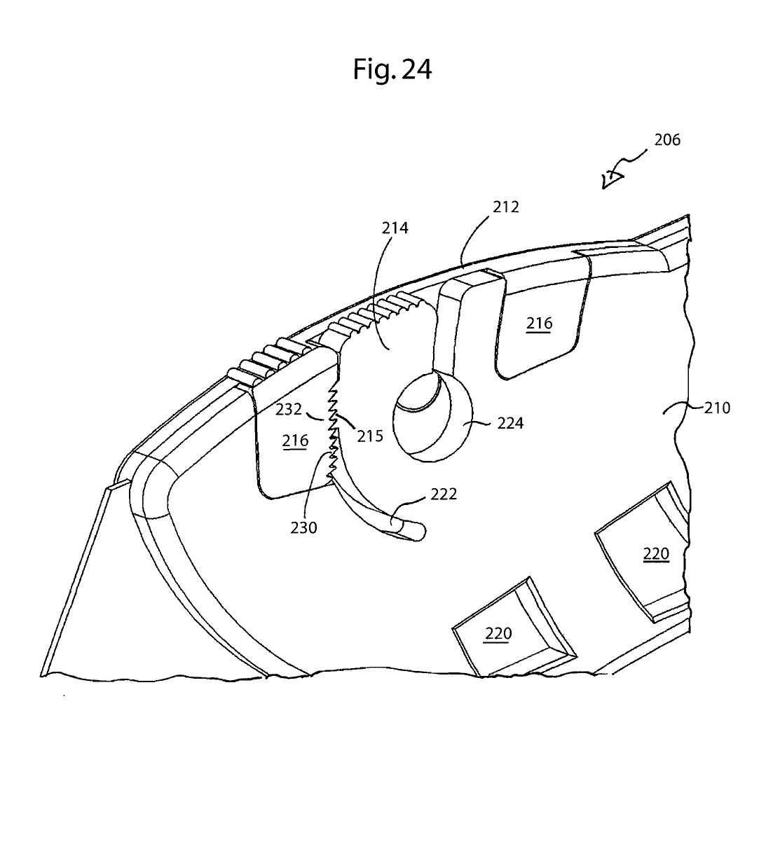

As is shown at least in FIGS. 23 and 24, in place of slider 22, cover jaw 210 is provided with an integrally-formed, spring-loaded ratchet arm 214, having teeth 215, which is sized and shaped and positioned to engage and selectively mechanically lock with a mating ratchet arm 216 integrally-formed with main jaw 212. This arrangement allows a user to even more quickly pivot open cover jaw 210 with respect to main jaw 212 by releasing the ratchet engagement and thereafter remove or insert a blade. Once in position, the blade 204 can be captured by projections formed onto both cover jaw and main jaw as cover jaw is pivoted with respect to main jaw. Once near their respective extents of motion (almost closed), ratchet arm 214 of cover jaw 210 will begin to engage with mating and aligned ratchet arm 216 of main jaw 212, effectively rotationally locking cover jaw 210 to main jaw 212. The user may squeeze the two jaws together (about the pivot connection to the knife) to further ratchet-engage the locking mechanism to a further tightened position, as necessary.

As in the earlier versions of this knife, the handle 202, the main jaw 212 and the cover jaw 210 are preferably made from a reinforced plastic that is suitable for injection molding manufacturing, such as Zytel®. Other plastics and even metal can be used, but injection molded plastic is preferred. To this end, to aid in the injection molding process, the main jaw 212 and cover jaw 210 are shaped so that no caming or core plate action is necessary during molding (simple planer molds may be used). In other words, both main jaw and cover jaw include no overhanging features and all surfaces may be “viewed” from either the top or the bottom of each part, respectively.

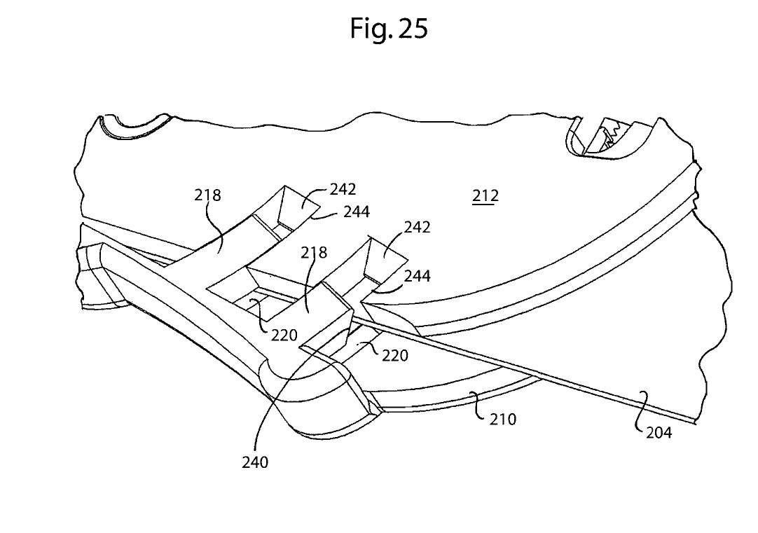

For example, as shown in FIGS. 23-26, cover jaw 210 includes two lower blade-capturing arms 218 and aligned openings 220. Openings 220 are sized and shaped and positioned so that otherwise hidden detail of arms 218 may be properly formed during the molding process through openings 220, as is well understood by those skilled in the art.

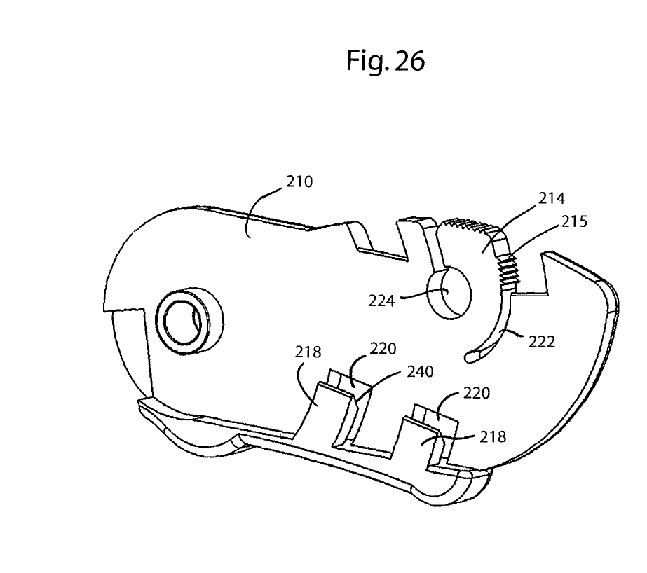

As detailed in FIGS. 24 and 26, ratchet arm 214, introduced above is integrally formed and includes flexure geometry defined by curved slot 222 and adjacent opening 224. Arm 214 includes ratchet teeth 215 and may be flexed between a lockable rest position, as shown in FIG. 24 and an unlocked position wherein arm 214 is forced back towards pivot point by a user's finger (described in greater detail below).

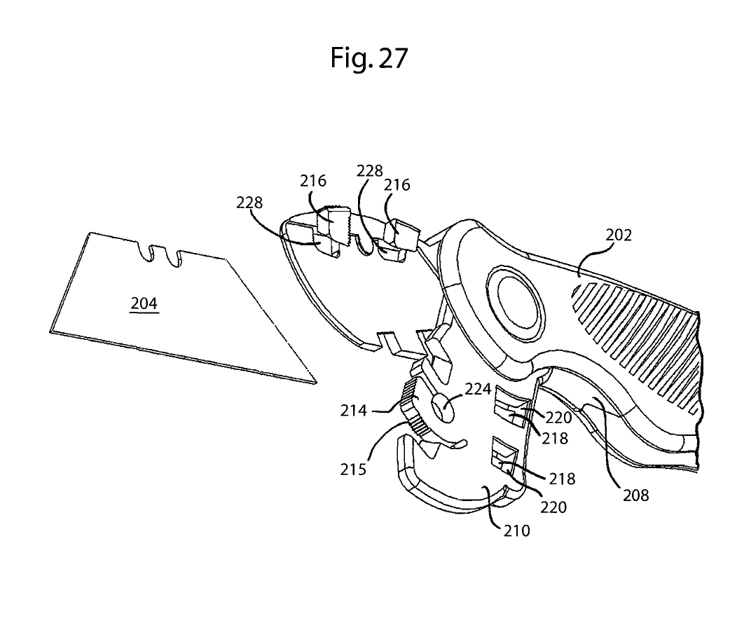

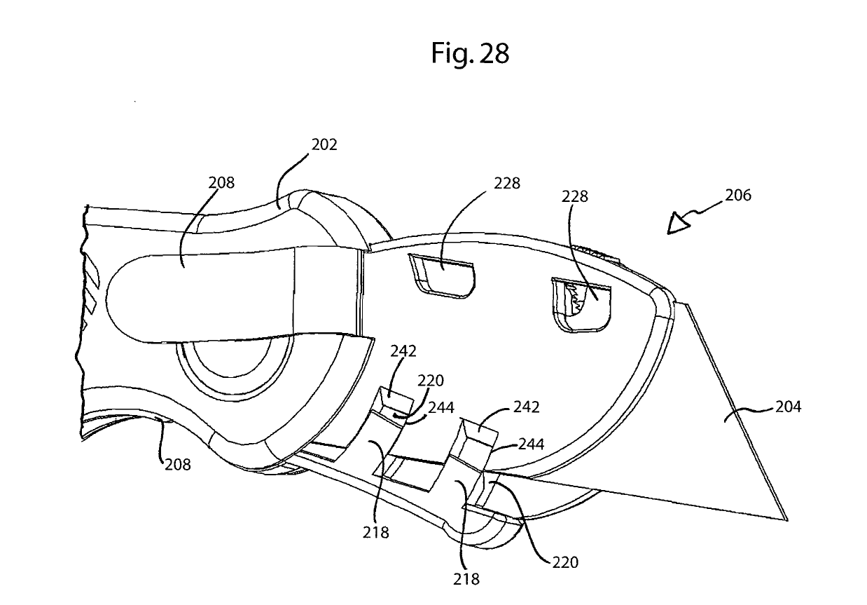

Referring now to FIGS. 27 and 28, main jaw 212 is shown including two upper blade-capturing arms 216 and two aligned openings 228. As with the above described cover jaw 210, the openings 228 are used to help the molding process by allowing otherwise hidden detail of arms 216 to be properly formed through openings 228. Ratchet teeth 230 are formed along a locking edge 232 of a forward arm 216, as shown in FIG. 24.

As in earlier embodiments of this patent application, main jaw 212 pivotally connects with cover jaw 210, at a pivot opening 234, which is sized to receive an appropriate pivot pin (not shown) so that both jaws can be pivotally connected to handle 202. Also, as before, main jaw 212 includes a blade-receiving recess 236 and a notch-receiving post 238 which are sized and shaped to snugly receive a conventional trapezoidal razor blade 204 (utility knife blade).

Once a blade 204 is in position against main jaw 212, cover jaw 210 may be pivotally closed. As cover jaw 210 nears a completely closed position, teeth 215 of ratchet arm 214 of cover jaw 210 first engage the mating teeth 230 of locking edge 232 of main jaw 212. When the teeth first engage, the two jaws will be locked and can only be further closed together, unless the ratchet is first released. As a user continues to squeeze cover and main jaws together, more teeth of both jaws will engage, further tightening the hold of the interposed blade 204. Eventually, cover jaw 210 and main jaw 212 can no longer be further closed with respect to each other and the blade will then be considered fully locked. As the teeth engage, the spring-biased ratchet arm 214 will flex against the spring-bias as needed to accommodate the teeth as they pass each other during the ratchet engagement.

Another benefit is that as the ratchet teeth engage with each other, a reassuring sound will be generated (click, click, click) which will help convey to the user that the blade is being secured properly. Although only one ratchet tooth, 215 and 230 for each ratchet is required, as described below, to allow cover jaw 210 to be selectively locked to the main jaw 212, several teeth 215 and 230 are preferred so that cover jaw effectively locks several times (as a safety) to main jaw. If, per chance, ratchet teeth 215 slips from engagement from ratchet teeth 230, adjacent teeth will catch the slipped teeth 215 and again ensure a locked arrangement. As described below, spring arm 214 must be drawn back and cover jaw 210 must be simultaneously pivoted from main jaw 212 until all teeth 215 clear all the teeth 230 before cover jaw can be considered unlocked. Also, as an added safety feature, as described above, the cover jaw 210 will be locked to its fully open position with respect to handle 202 when liner lock is engaged within the tang of cover jaw 210 (main jaw 212 cannot pivot if cover jaw is engaged by liner lock).

As in earlier embodiments, lower blade-capturing arms 218 of cover jaw 210 include angled surfaces 240 which are sized and shaped and positioned to snugly engage with opposing angular surfaces 242 of main jaw 212 (see FIG. 28), when cover jaw moves to its fully closed and locked position with respect to main jaw 212. Arms 218 of cover jaw 210 are preferably curved (concentric to the pivot point A) to snugly fit into arcuate channels 244 of main jaw 212.

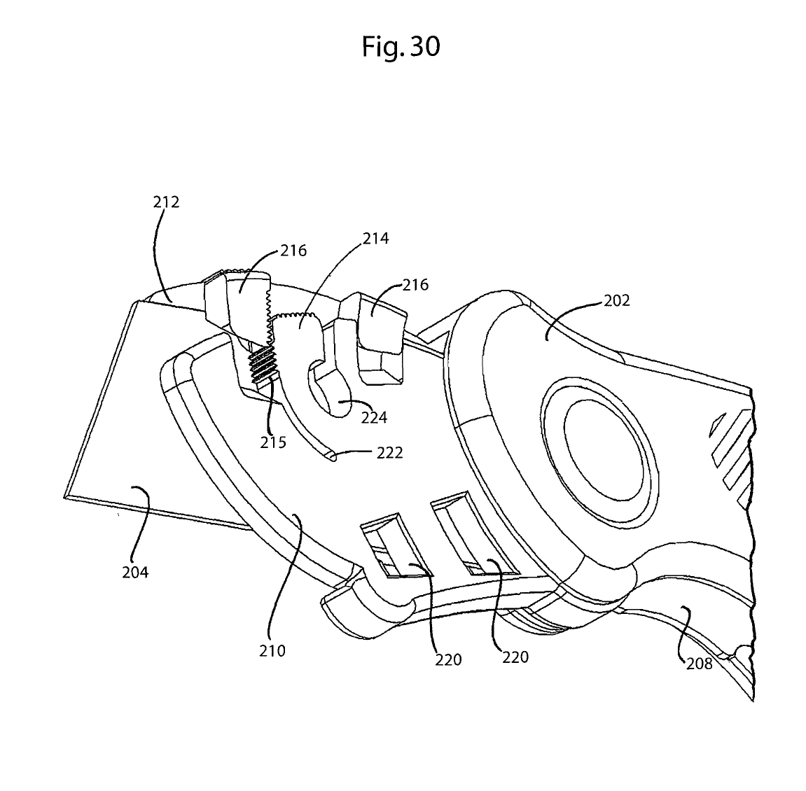

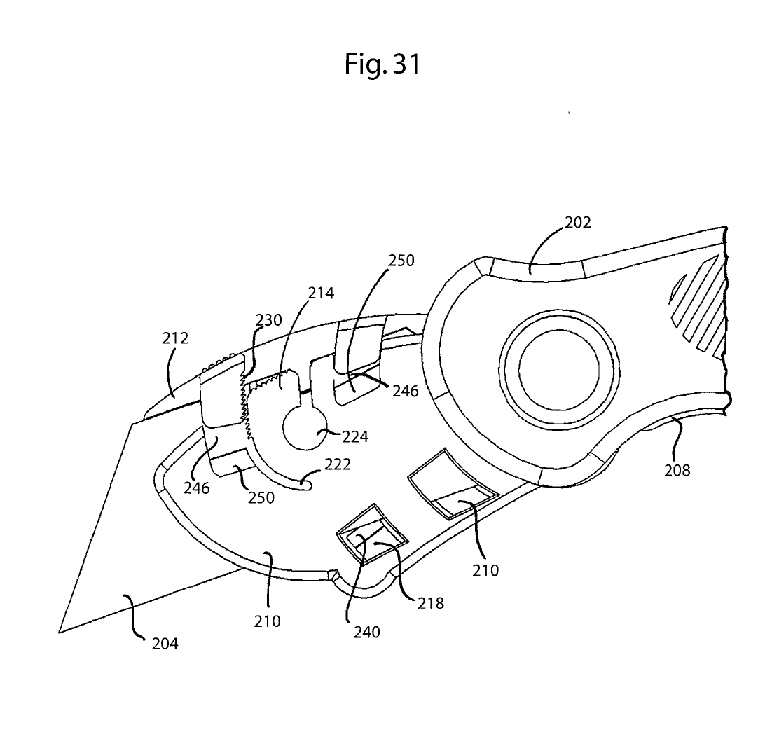

Similarly, as shown in FIG. 31, upper blade-capturing arms 216 of main jaw 212 are curved (concentric to the pivot point A) to snugly fit into mating openings 246 of cover jaw 210. Also, as shown in FIGS. 26 and 30, arms 216 of main jaw 212 include angled surfaces 248 which are sized, shaped and positioned to snugly engage with opposing and mating angular surfaces 250 of cover jaw 210, as shown in the figure.

As cover jaw 210 closes into locking engagement with main jaw 212, several mating surfaces of cover jaw engage with corresponding mating surfaces of main jaw to help the two jaws hold the interposed blade 204 tightly therebetween. As mentioned above, when engaged, the angled surfaces of both jaws help squeeze or force the two jaws tightly against the blade, thereby helping keep the blade stable and tightly held. The notch-receiving post 238 and blade-receiving recess 236 prevent the blade from moving back and forth, keeping it between the jaws. Finally, the curved arms of both jaws, when engaged, help prevent effects of torque or twisting on the jaws during use, thereby maintain the blade straight and aligned as expected by the user.

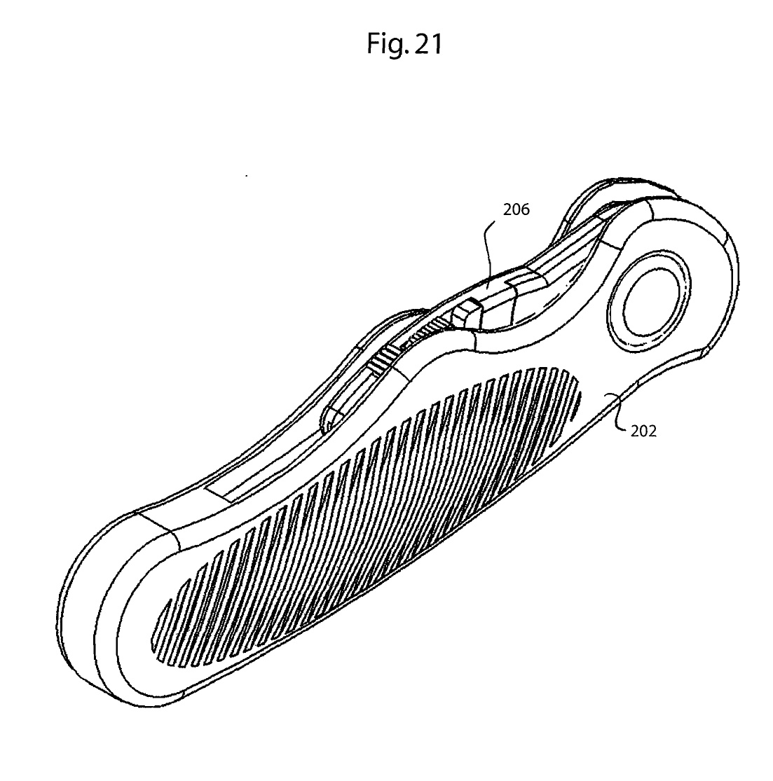

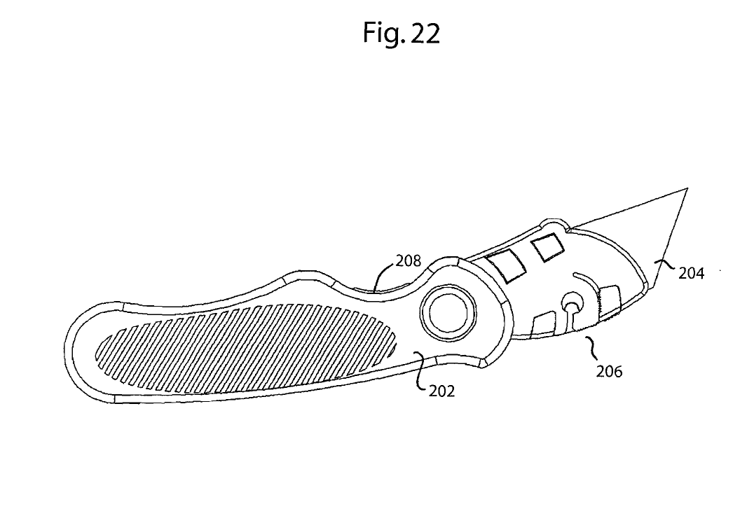

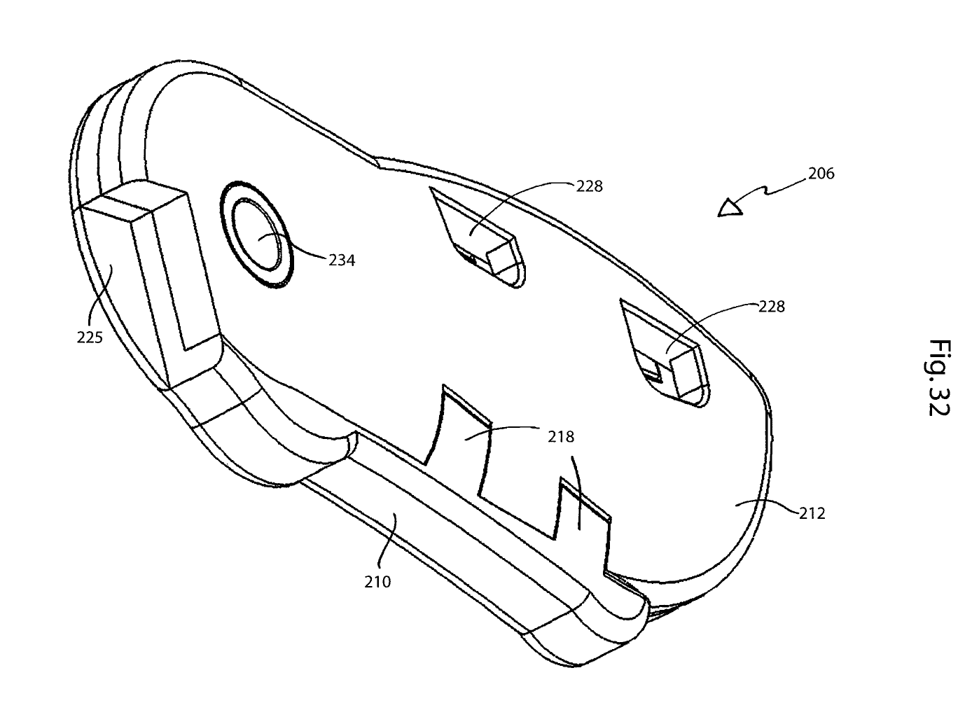

As before, when a blade 204 is properly locked into jaws 210, 212, the jaw holder 206 (both jaws locked together) is pivotal with respect to handle 202 between a fully stowed position, as shown in FIG. 21, wherein blade holder 206 and blade 204 are located within handle 202 and a fully open and locked position wherein blade holder 206 and blade are in a cutting position, as shown in FIGS. 20 and 22. As before, when blade holder 206 is in its fully open and locked position, engagement end (not shown for this embodiment, but the same as engagement end 38 of earlier described embodiments) of liner lock (like liner lock 14) moves under its spring bias into locking engagement with a tang portion of blade holder 206 so that blade holder remains in the locked position, until released. As shown in FIG. 32, cover jaw 210 includes a wall 252 within locking region of the tang portion. Wall 252 cradles engagement end 38 of liner lock 14 when engaged so that engagement end 38 cannot slip between blade holder 206 and handle 202, as sometimes happens with conventional liner lock arrangements. As before, engagement end 38 includes an “L” shape which is designed to prevent liner lock slippage and also helps keep main jaw and cover jaw locked together when blade holder 206 is locked. With this arrangement, during use, a user cannot accidentally open cover jaw 210 and release blade 204 because both jaws are locked together by both the ratchet lock mechanism and the liner lock engagement end 38.

Although the ratchet arrangement of this embodiment is shown in a forward position of main and cover jaws, it is to be understood that one or more ratcheting mechanisms can be positioned anywhere along the two jaws so that the ratcheting action automatically locks the jaws together as the pivotally close. Also, the number, size and shape of the ratchet teeth can vary from one to many depending on the particular design of the knife and the parts.

In insert a blade, as in earlier embodiments, a user of the knife first opens blade holder 206 from its stowed position within handle 202 to a blade-changing position (located anywhere between fully stowed within the handle and fully locked positions). The user then holds blade holder 206 and using a finger pulls back on spring arm 214 (towards the pivot opening 234) until teeth 215 disengage from teeth 230, at which point, cover jaw 210 is allowed to pivot with respect to main jaw 212. The user may simultaneously use his index finger and thumb to pivot open the now-released jaws, similar to the action of rolling a pencil between the thumb and the index finger.

Once the jaws are open, the user can then easily insert a blade into blade-receiving recess 236 and align one of the two notches of the blade with notch-receiving post 238 and then as a last step, pivotally close the cover jaw 210 with respect to main jaw 212.

As the user squeezes the jaws closed, eventually, the ratchet teeth 215 will engage with ratchet teeth 230 against the action of the spring-bias of ratchet arm 214. The teeth, 215, 230 are shaped to function as a one-way lock wherein each engagement of teeth will further lock the cover jaw 210 pivotally with respect to main jaw 212. The cover jaw 210 will then only be able to be further closed, but not opened (unless spring arm 214 is against pulled back against its spring-bias (which is created through its natural resiliency).

The user will continue to squeeze cover jaw 210 against main jaw 212 until ratchet teeth 215, 230 can no longer advance, at which point, blade 204 will be fully locked within blade holder 206. The user can then fully pivot open the combined blade holder 206 until it is in its fully open and locked position, or pivot the blade holder back into handle 202, as desired.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different claims set forth below may be combined in various ways in further accordance with the present invention.

What is claimed is:

1. A knife for holding a razor blade, of the type that includes a sharpened lower edge and an upper edge that includes at least one notch, the knife comprising:
a handle;
a main jaw having a first bore at a pivot end, an upper edge, a first blade-receiving surface shaped to receive the upper edge of the blade and a post projecting from the blade-receiving surface sized and position for receiving the at least one notch of said blade;
a cover jaw having a second bore at a pivot end and a second blade receiving surface shaped to receive the lower edge of the blade, the main jaw and the cover jaw being pivotally connected to the handle at a pivot axis about the first and second bores, respectively, so that the main jaw and the cover jaw can angularly pivot about the pivot axis between an open position, wherein the cover jaw and the main jaw are angularly separated, and a closed position, wherein the main jaw and the cover jaw are adjacent with respect to each other; and
a slider that is slidingly coupled to the main jaw and is movable between a locking position in which the main and cover jaws are locked to one another with the blade being held therebetween and a releasing position in which the main and cover jaws can angularly pivot with respect to one another.

2. The folding knife of claim 1, wherein the main jaw includes an inner face that includes a first slider channel and an opposite outer face that includes a second slider channel, the slider slidingly traveling within the first and second slider channels, wherein in the locking position, the slider engages a portion of the cover jaw, thereby locking the two jaws to one another.

3. The folding knife of claim 2, wherein the cover jaw includes a projection along its upper edge and a third slider channel, the projection being received within a cutout formed along the upper edge of the main jaw and the third slider channel aligns with first slider channel when the jaws are in the closed position, the slider being received within the third sliding channel in the locking position.

4. The folding knife of claim 1, further including a locking detent to assist in holding the slider in the locking position.

5. The folding knife of claim 1, wherein the main and cover jaws are snap-fittingly mated to one another in a manner in which the main and cover jaws can pivot relative to one another.

6. The folding knife of claim 5, wherein the main and cover jaws are snap-fittingly mated to one another at the pivot axis about the first and second bores.

7. The folding knife of claim 6, wherein the cover jaw includes a snap collar formed about the second bore for snap-fittingly mating with a flange that is associated with the first bore of the main jaw.

8. The folding knife of claim 1, wherein the cover jaw includes a first beveled portion along its upper edge that is received within the first blade-receiving surface of the main jaw and mates with a second beveled portion of the first blade-receiving surface.

9. The folding knife of claim 1, wherein the first blade-receiving surface of the main jaw comprises a first channel and the second blade-receiving surface of the cover jaw comprises a second channel, each of the first and second channels including an inside beveled edge that mate with complementary beveled edges that are part of an upper edge of the cover jaw and a lower edge of the main jaw.

10. The folding knife of claim 1, wherein the cover jaw includes a display area on which indicia can be placed and a viewing window is formed in the handle, wherein the closed position, the indicia in the display area is visible through the viewing window.

11. A knife for holding a razor blade, of the type that includes a sharpened lower edge and an upper edge that includes at least one notch, the knife comprising:
a handle;
a main jaw having a first bore at a pivot end, an upper edge, a first blade-receiving surface shaped to receive the upper edge of the blade and a post projecting from the blade-receiving surface sized and position for receiving the at least one notch of said blade;
a cover jaw having a second bore at a pivot end and a second blade receiving surface shaped to receive the lower edge of the blade, the main jaw and the cover jaw being pivotally connected to the handle at a pivot axis about the first and second bores, respectively, so that the main jaw and the cover jaw can angularly pivot about the pivot axis between an open position, wherein the cover jaw and the main jaw are angularly separated, and a closed position, wherein the main jaw and the cover jaw are adjacent with respect to each other; and
a locking mechanism for selectively locking the main and cover jaws to one another with the blade being held therebetween.

12. The folding knife of claim 11, wherein the locking mechanism comprises a ratcheting mechanism that includes a first ratchet part that is associated with the main jaw and a second ratchet part that is associated with the cover jaw.

13. The folding knife of claim 11, wherein the locking mechanism comprises a slider that is slidingly coupled to the main jaw and selectively engages the cover jaw in a locking position where the two jaws are locked to one another.

14. A knife for holding a razor blade, of the type that includes a sharpened lower edge and an upper edge that includes at least one notch, the knife comprising:
a handle;
a main jaw having a first bore at a pivot end, an upper edge, a blade-receiving surface shaped to receive the blade and a post projecting from the blade-receiving surface sized and position for receiving the at least one notch of the blade, the main jaw including at least one first ratchet tooth;
a cover jaw having a second bore at a pivot end and an upper edge, the cover jaw including at least one second ratchet tooth;
the main jaw and the cover jaw being pivotally connected to the handle at a pivot axis about the first and second bores, respectively, so that the main jaw and the cover jaw can angularly pivot about the pivot axis between an open position, wherein the cover jaw and the main jaw are angularly separated, and a closed position, wherein the main jaw and the cover jaw are adjacent with respect to each other; and
the main and cover jaws being shaped and pivotally attached so that the first ratchet tooth and the second ratchet tooth interlocking engage one another when the main jaw and the cover jaw are in the closed position so that the jaws are locked to each other.

15. The folding knife of claim 14, wherein the main jaw includes two upper blade-capturing arms that extend downwardly from the upper edge of the main jaw, the first ratchet tooth being formed as part of one of the upper blade-capturing arms.

16. The folding knife of claim 15, wherein an upper edge of the cover jaw includes openings that receive the two upper blade-capturing arms and a lower edge includes two lower blade-capturing arms received within openings formed along a lower edge of the main jaw.

17. The folding knife of claim 14, wherein the cover jaw includes a wall that cradles an engagement end of a liner that is disposed within a cavity of the handle.

18. The folding knife of claim 14, wherein the second ratchet tooth is part of a spring-loaded ratchet arm.

19. The folding knife of claim 18, wherein the spring-loaded ratchet arm is defined by a slot formed in the cover jaw on one side of the arm and an opening formed on the other side of the arm.

20. The folding knife of claim 18, wherein the spring-loaded arm includes a roughened top surface and the second tooth is formed along a side edge of the arm, the first tooth being formed along an inner side edge of an upper blade-capturing arm that extends downwardly from the upper edge of the main jaw.
